(19) United States
(12) Patent Application Publication
(10) Pub. No.: US 2002/0042835 A1
(43) Pub. Date: Apr. 11, 2002

(54) Method and apparatus for enabling bulk loading of data

(76) Inventors: Christine S. Pepin, Melbourne Beach, FL (US); Jeffrey W. Leonard, Melbourne, FL (US)

Correspondence Address: BANNER & WITCOFF, 1001 G STREET N W, SUITE 1100, WASHINGTON, DC, 20001, US

(21) Appl. No.: 09/820,324

(22) Filed: Mar. 29, 2001

Related U.S. Application Data
(60) Provisional application No. 60/192,877, filed on Mar. 29, 2000.

(51) Int. Cl. G06F 15/16; G06F 17/00

(52) U.S. Cl. 709/232; 707/104.1; 709/101; 709/219; 709/231; 707/101

(57) ABSTRACT

A system and method for processing information performs actions associated with rules to modify, adjust, calculate and massage data to comport with downstream handling requirements. In one example, bulk uploads from a supplier are treated in accordance with column headings to perfect data to be imported into a marketplace. The system also permits the storage of the rules to process later uploads with similar data structures. The similar data structures may be determined through matching the supplier and marketplace sites with the saved sets.

### RELATED APPLICATIONS

This disclosure is related to U.S. Provisional Application Nos. 60/192,877, filed Mar. 29, 2000, 60/199,357, filed Apr. 25, 2000, and 60/235,890, filed Sep. 28, 2000, each of whose contents are expressly incorporated by reference.

### BACKGROUND

1. Technical Field

The invention generally relates to transferring information. More particularly, the invention relates to bulk transfers of information between applications.

2. Related Art

Marketplaces distribute inventory and services. Online marketplaces provide a valued resource to companies that need to sell products and services. These marketplaces also act as clearinghouses for volumes of information. Despite significant capital invested in improving the marketplaces, getting information to the marketplaces remains difficult.

One difficulty is the number of different data formats used by the entities providing content (referred to as “suppliers”) to the marketplaces. While each supplier may provide electronic versions of its information it needs to be addressed by the marketplace, there is no uniformity among all suppliers for the file formats. Even where some uniformity is achieved by enforcement from the marketplaces, each marketplace is different. So, even though a supplier may modify its data format to accommodate a first marketplace, the supplier is prevented from using the new data format for other marketplaces requiring a different data format. This engendered single supplier to single market solutions.

For example, auctions have become popular in the internet marketplace. The supplier will generally use a preexisting marketplace to dispose of excess inventory. Currently, this means that the supplier needs to obtain from the marketplace the precise list of fields that need to be completed (for example, the price, quantity, and at least one type of item identifier) as well as other fields (for example, pictures and the like). The supplier then needs to create an uploadable data set that satisfies the requirements of the marketplace. Here, the supplier wanting to upload its data must wade through attempting to adequately remap its existing file into a form compatible with the marketplace. Further, unless the supplier wants to completely reorganize its internal file structure, the laborious task of remapping and renaming fields needs to occur as part of each upload process.

Assuming the supplier wants to minimize its workload for repeated uploads, it may reorganize the data structure to fit that of the marketplace. However, as no two marketplaces have identical data structures, the supplier automatically creates additional work for itself if it wants to use more than one marketplace to dispose of excess inventory. This is because the supplier, in adjusting its data structure to fit the first marketplace, has modified the data structure to be non-identical with that of the second marketplace. So, the supplier is forced to constantly remap its data structure to accommodate all marketplaces. Other types of marketplaces that encounter similar difficulties include, but are not limited to, exchanges, classified posting sites, and RFQ (request for quote) sites.

Another difficulty with marketplaces is that they require marketplace-specific information that is not generally stored as part of the supplier's data set. Marketplaces may require quantity or batch information, damage waivers, history information, and the like. As a specific example, auctions require information like minimum bid increments, minimum initial offers, reserve amounts and the like. While the marketplaces may default to generic values, the specification of these values is troublesome for buyers, suppliers and marketplaces alike as 1) diverse products or services may have diverse requirements (for example, intact automobiles v. pencils) and 2) the set of suppliers may different requirements (for example, some may want to start bidding at an auction site at one point, others may want to start bidding at another point). Accommodating these varying requirements has meant that each supplier or each marketplace specify these values for each entry. For sets of data with thousands of entries, modifying each is labor prone and error prone. Further, there is no current way of handling divergent datasets where information needs to be addressed individually. Accordingly, an improved bulk loading system is needed.

### SUMMARY

The present invention relates to a loader for loading information between applications. One aspect of the present invention relates to selection of first and second labels to identify sets of data then application of rules based on the selected labels. In another aspect of the present invention, the designation of labels for sets of data may be modified with each selection or assignment of the labels. This provides the benefit of two or more sets of data sharing the same label. In an alternative embodiment, the sets of available labels are always the same.

In a third aspect of the present invention, the system determines additional sets of data to be included with the original data. The additional data may be computed from existing data in the original data set as well as include reference to further information stored elsewhere.

In a fourth aspect of the invention, the multiple rules may be applied based selected headings. Here, some rules may or may not be applied based on the identity of the supplier, the identity of the auction site, and the instant transaction occurring.

In a fifth aspect of the invention, the application of rules is stored in a knowledgebase. When new transactions are to be processed, the knowledgebase is queried to determine if the supplier had previously submitted a similar set of information to be processed for a recipient. If so, the system attempts to reuse the stored rules to eliminate manual loading.

In a sixth aspect of the invention, the business rules may be applied, not only to sets of data (for example, all columns or fields with a specified label), but also to individual cells based on their contents or the contents of other cells.

These and other novel advantages, details, embodiments, features and objects of the present invention will be apparent to those skilled in the art from following the detailed description of the embodiments, the attached claims and accompanying drawings, listed herein, which are useful in explaining the invention.

### BRIEF DESCRIPTION OF THE DRAWINGS

FIG. 1 shows a first embodiment of the invention.

FIG. 2 shows a second embodiment of the invention with various processes.

FIG. 3 shows different processing layers in accordance with embodiments of the invention.

FIG. 4 shows a process flow in accordance with embodiments of the invention.

FIG. 5 shows a flowchart of various procedures in accordance with embodiments of the invention.

FIG. 6 shows a physical structure of system in accordance with embodiments of the invention.

FIG. 7 shows different data processing steps in accordance with embodiments of the invention.

FIG. 8 shows a system flow between multiple suppliers and recipients in accordance with embodiments of the present invention.

FIG. 9 shows a list of marketplaces and their various commerce models in accordance with embodiments of the present invention.

FIG. 10 shows a list of files ready to be uploaded to a marketplace in accordance with embodiments of the present invention.

FIG. 11 shows a user interface for ordering a rules operation in accordance with embodiments of the present invention.

FIG. 12 shows a user interface for modifying business rules in accordance with embodiments of the present invention.

FIGS. 13A-13C show a list of business rules in accordance with embodiments of the present invention.

FIGS. 14-26 show various user interfaces of a system according to embodiments of the present invention.

FIGS. 27 and 28 show processes for binding information together to create a workspace for a user according to embodiments of the present invention.

FIGS. 29-30 show descriptions for various user s of the system a n d associated objects utilized based on which user is using an embodiment of the present invention.

FIGS. 31-36 show a data structure that may be used with the system according to embodiments of the present invention.

FIG. 37 shows a data flow process in accordance with embodiments of the present invention.

FIG. 38 shows an example of rules processing on a t able in accordance with embodiments of the present invention.

### DETAILED DESCRIPTION

The present invention is described by way of embodiments. It is appreciated that the embodiments are provided by way of example only. In keeping with the scope of the invention, it is noted that modifications of the embodiments may be made without departing from the invention, whose scope is defined by the claims.

The various elements described herein may be implemented on general-purpose computers and databases as are known in the art. Known storage systems may be used to store the various information sets as transferred about the system. These systems may include databases, knowledgebases, file structures, hard drives, optical drives, removable drives, static memory, and the like.

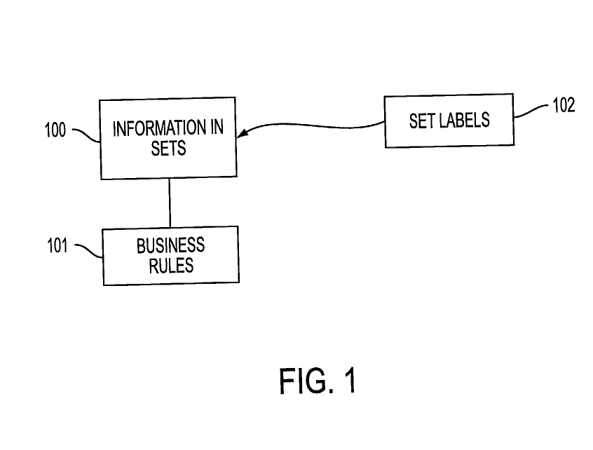

FIG. 1 shows a first embodiment of the invention in which information in sets 100 has labels applied to it. The information 100 may take a variety of forms including a table (.xls or .doc), comma separated values (.CSV) file, a text file (.txt), a database (.dbf), proprietary files, non-delimited files and the like. It is appreciated that any file format may be used. Based on the selected labels, business rules (also referred to as rules) 101 are applied to the information 100.

The application of the rules 101 may have a variety of effects. First, the rules 101 may eliminate parts of information 100. This elimination may be performed as a type of data scrubbing to eliminate unwanted information. For example, periods may be eliminated after an abbreviation designating a state (e.g., “V.A.” scrubbed to “VA”).

Second, the rules 101 may filter the information 100 to permit only certain parts of the information 100 to remain. For example, if the information contains zip codes and the business rule 101 is to filter out zip codes, the zip codes are removed during the application of the business rule 101 while leaving the remaining information.

Third, the rules 101 may include rules pertinent to the supplier of the information 100. For example, the supplier may have a requirement that the buyer assumes all shipping liability for a first set of products. For a second set of products, the supplier may have the requirement that the supplier assumes all shipping liability. The execution of the business rules 101 may modify the information 100 to include these requirements. In the simplest of forms, the information 100 may be in a table form and the business rules 101 may add a column of data that pertains to all entries in the table. In a more complex example, the information 100 may have a variety of different entries with each needing its own evaluation. The use of the business rules permits known entries to be addressed with the remainder to be handled in due course by, for example, more rules 101 or by an operator.

Fourth, the rules 101 may include rules pertinent to the receiver of the information 100. For example, the receiver of the information 100 may be an auction site with its own set of requirements. For example, the auction site may require pictures or thumbnail graphics be associated with products and services. The business rules 101 permit the incorporation of images with the information 101 or alternatively include links to the images for transmission to the auction site. In another example, a second auction site may require the supplier to specify a minimum bid and a reserve price. The execution of the rules 101 may derive the minimum bid and reserve price from the information 100. This is also referred to as a derivation rule, in which information is derived from other information in this example of the rule. In a third example, a third auction site may have its own minimum bid that the supplier may not override. Here, the business rules 101 may permit the supplier to specify its own minimum bid down to the minimum bid required by the third auction site.

Fifth, the rules 101 may include cleanup rules that address any remaining issues. For example, one rule may include eliminating a source's header row post processing.

Sixth, the rules 101 may apply data mappings from one set of data to another.

Seventh, the rules 101 may accommodate derivative rules as described above. For instance, if a marketplace needs to convert information from Canadian dollars to U.S. Dollars for a Canadian supplier providing information to a U.S. marketplace, the business rules need to derive a new set of data (here, a conversion) from another set of data.

In an embodiment of the invention, the rules apply to columns or fields and act on them based on a label identifier. In an alternate embodiment, the rules may apply further to specific cells or fields. For example, one supplier may supply information containing a number of entries. For example, a bank may forward a table with all EDI transactions that have occurred with the bank as separate entries in the table. A business rule that may run on the table includes a rule that 1) determines the routing number or other identifier for a first cell in a row of information, 2) processes a second cell based on the data within the first cell and 3) forwards a resulting data set or the resulting data set and other relevant information of the row to a clearinghouse associated with the routing number. In this regard, a first row may be forwarded to a first clearinghouse and a second row forwarded to a second clearinghouse. In short, each row may be separated and processed in accordance with the business rules.

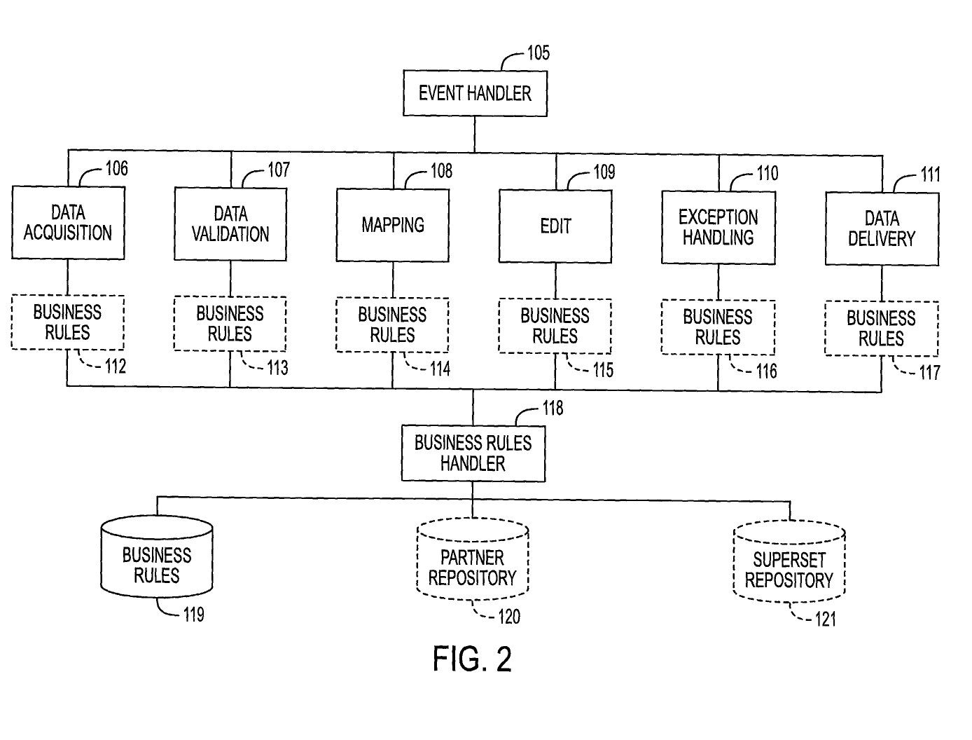

FIG. 2 shows another embodiment of the invention. Event handler 105 receives an event (for example, new information 100 being loaded into the processing system of FIG. 2). Next, various processes may be performed on the received information 100. Business rules may or may not be applied at each process. It is noted that not all processes need to be performed to adequately handle information 100 for an end user. The various processes include: data acquisition 106, data validation, 107, mapping 108, edit 109, exception handling 110, and data delivery 111. Business rules 112-117 may be applied, respectively. By the fact that business rules 112-117 are shown in dotted boxes, not all are required to realize the embodiment of FIG. 2. The business rules handler 118 handles the various business rules as needed by processes 106-111. The business rules handler 118 retrieves specific business rules as needed from knowledgebase of business rules 119.

FIG. 2 also includes a partner repository 120 and a superset repository 121. The partner repository 120 includes stored transform sets that may be used to automatically apply the business rules when the information 100 is sufficiently identified to pertain to the stored sets to be applied to the information. The stored sets relate to previous sets of applied labels from superset repository 121. When storing information in the partner repository 120, portions of information 100 are identified as retained. For example, the partner repository 120 may contain a transform table that links received information 100 to various labels stored in superset repository 121. The transform table may contain identifiers of the labels contained in superset 121. A transform table stored in partner repository may take the form of:

| Transform Table | |
|---|---|
| ID | |
| Supplier ID | Recipient ID |
| Header Row | Header Row ID |
| Location | |
| Column 1 | Transform Label |
| | to X |
| Column 2 | Transform Label |
| | to Y |
| Column 3 | Transform Label |
| | to Q |
| Column N | Transform Label |
| | to W |

In the above transform table, the transform table ID stores an identifier to uniquely identify the transform table. The supplier ID stores the identity of the supplier. This may take a variety of forms including the name of the supplier, the person who is actually supplying the information, another ID or any combination of these identifications. Similarly, the recipient ID stores an identifier for the recipient. The recipient ID may be the actual name of a recipient, a person who works for the recipient, another identifier for the recipient or any combination of these identifications. The header row location identifies where in the currently received information a header row may be found. The header row ID specifies information to match with information in the received header row. For example, the header row ID may contain entries including “Quantity”, “Serial No.”, “Sell-by Date”, and the like. Another header row ID may include “Quant.”, “SBD”, and “SN”. The system attempts to match the header row ID information with that from received information 100. If the match is good, the labels X, Y, Q, W are applied as headers to columns 1, 2, 3, N, respectively. Next, based on these labels (X,Y,Q,W), the business rules from business rules repository 119 may be applied.

The superset repository 121 includes a description of all available labels that may be applied to information 100. When selecting the labels to be applied, the set of all available labels in 121 may be reduced based on the identity of the supplier or the recipient of the information to simplify the selection of labels for information 100.

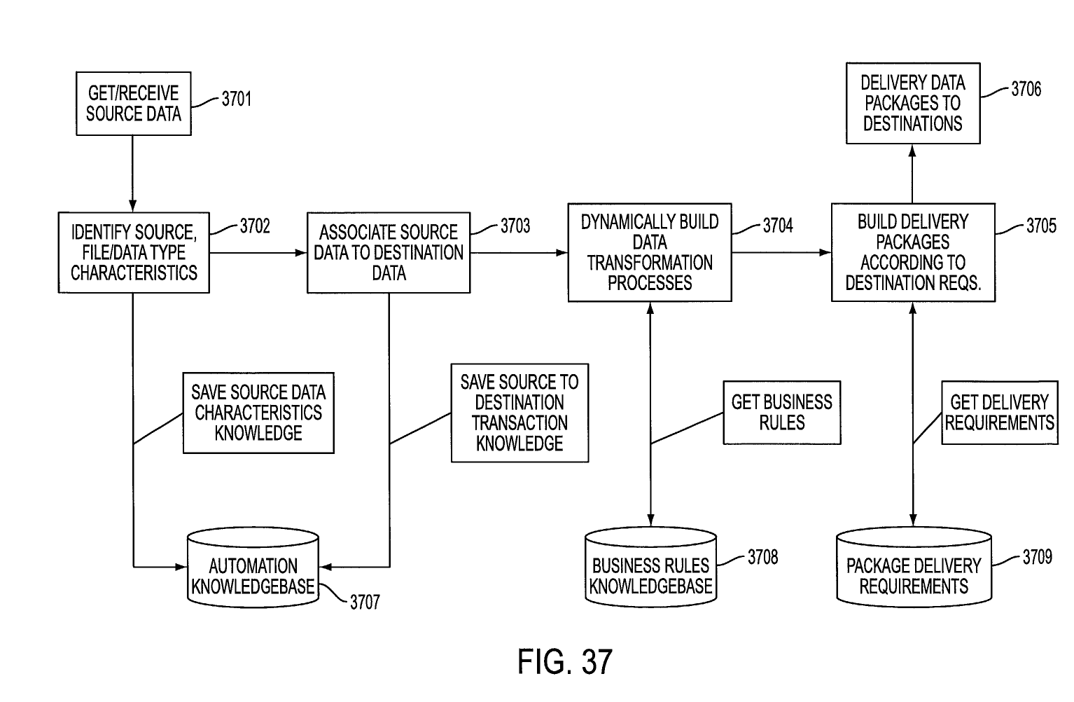

FIG. 37 shows a process flow according embodiments of the present invention. From getting or receiving source data in step 3701 through delivering data packages to destinations in step 3706, the system executes a transaction. The transaction may be considered to have three components. First, the transaction includes source data (from a source application, where the data can be interpreted according to a data format schema). Next, the transaction includes data relationships and business rules (A process or method for associating data attributes between disparate systems to enable interoperability between systems). Third, the transaction includes destination data (data schema requirement of the destination application). A data schema defines the data format, type and any characteristic about the data.

As shown in FIG. 37, the system gets or receives source data in step 3701. In step 3702, the system identifies the source, file and/or data type characteristics of the received data. In step 3703, the source data is associated with the destination data. In step 3704, the system dynamically builds data transformation processes. In step 3705, the system builds delivery packages according to destination rules. In step 3706, the system delivers data packages to destinations.

Automation knowledgebase 3707 saves source data characteristics knowledge discovered in step 3702. The knowledgebase 3707 also saves source to destination transaction knowledge for future reuse. Business rules knowledgebase 3708 exchanges business rules in step 3704. The package delivery requirements database 3709 exchanges delivery requirements in step 3705.

Business Rules formulate the basis of the Dynamic Transformation Engine. Utilizing a business rule library (related to the business rules knowledgebase 3708), business rules are created once and their usage assigned many times to accommodate many different source-to-destination transactions.

Business rules are triggered based on the relationships of the Source-to-Destination transactional requirements. A transaction can include 1-to-many associated relationships between the source and destination application. Elemental data relationships are associated with the dynamic transformation processes needed to transform the source data to the destination requirements. The mechanism for these transformations is the defined processes of business rules.

Business Rules have different attributes that control their execution and precedence.

1. Business rules execute at a Set or Database level, where application of the rule is applied to the entire set of data.

2. Business rules execute at a column level, where application of the rule(s) is applied to all data for the column within the entire set of data.

3. Business rules execute at a row level, where application of the rule(s) is applied to a select criterion of data based upon a subset of data for some column.

4. Precedence is defined by process set identifiers as well as business rule definitions. Process ID's group and order execution of business rules to meet the requirements of the source to destination application.

5. Process Groups can be executed dependent or independent of one another, creating a dynamic process flow with complete Boolean logic based flow processing.

For example, business rules may be assigned to a process set. The process set group ID is the root of the process, with sub-group ID's providing dependent process steps. All process steps are business rules.

Order of Precedence is also guided the unique transaction process defined by a source-to-destination transaction. In this scenario, default business rules can be put in place to execute the transaction, however, in some instances the source data may be governed by a more specific business rule than offered by a generic transaction rule. This could also be true for the destination data, where a business destination rule may need to supercede a transactional business rule. In both cases, there does not need to be a transactional business rule for either the source or destination business rules to function.

In all cases the business rules control the data flow, transformation, derivation, filtering, error processing, etc. of the source-to-destination transaction.

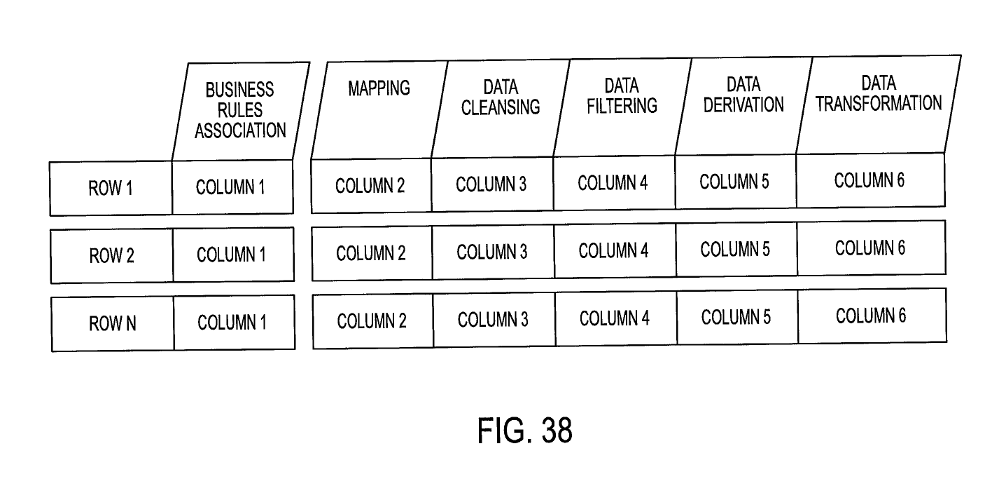

FIG. 38 shows the various business rules and how they apply to a sample table.

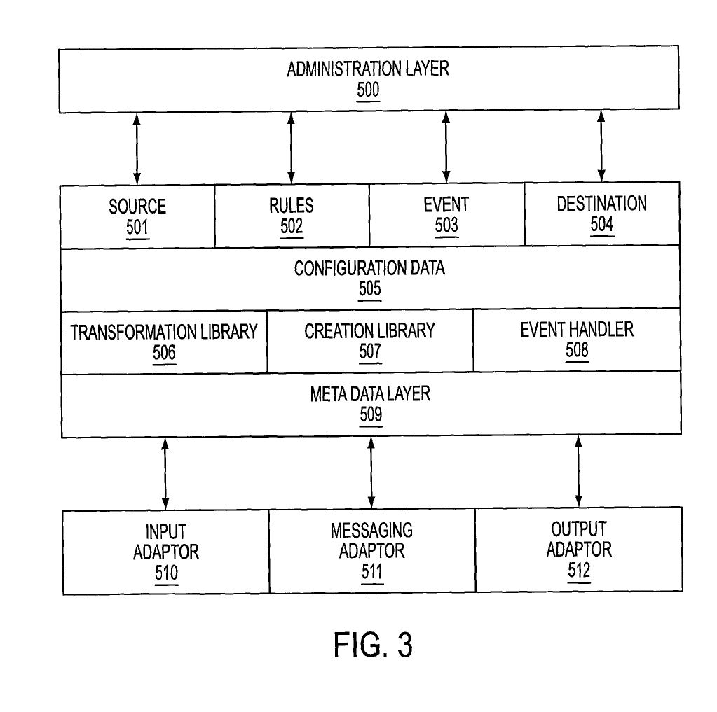

FIG. 3 shows an embodiment of various layers of software. DLLs may be used for data transformation, event handling and configuration. The configuration data 505 includes source and destination configurations (501 and 504), business rules 502, and event configurations 503. The administration layer 500 may take the form of a browser-based interface (or any other GUI) to administer the system. Multiple configurations may be maintained in a single location. The various libraries include a transformation library 506, a creation library 507 and an event handler 508. The meta-data layer 509 coordinates the processing of information from the libraries to the input 510, the messaging adaptor 511 and the output 512.

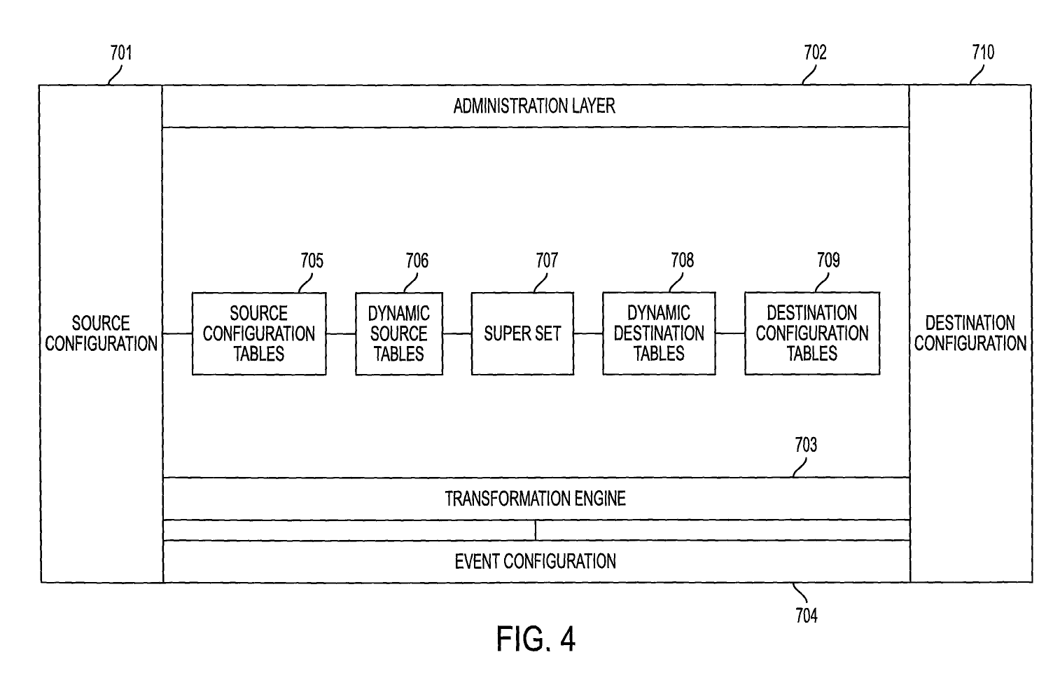

FIG. 4 shows a data transformation architecture. Information in a source configuration 701 is transformed into information with a destination configuration 710. The transformation engine 703 moves information between various stages including identifying and data transformations with source configuration tables 705 and dynamic source tables 706. Next, the information is correlated with information from the superset 707. Further processing is applied with the dynamic destination tables 708 and the destination configuration tables 709. The result is output as the destination configuration 710. The embodiment of FIG. 4 also includes an administration layer 702 and an event configuration layer 704.

The difference between the configuration/destination tables and the dynamic source tables are as follows:

1. The source configuration tables are static tables that contain all pertinent data regarding the source data file, structure, owner, format and other characteristics;

2. The destination configuration tables are static tables that contain all the data attributes necessary to define the destination environment, data types, required fields, optional fields, derived fields, default values, etc.; and

3. The dynamic source tables are created dynamically by the Dynamic Transformation Engine for the purpose of taking the associated source data and transforming it to the required destination formats.

The data exchange platform may include a Windows® 2000 Server, active server pages, COM+ and DLL components, stored procedures, an SQL Sever 7.0 and a JDataConnect Java grid.

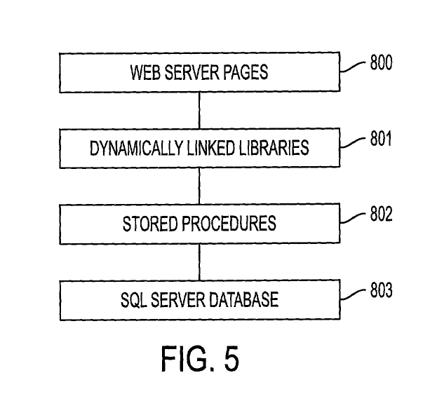

FIG. 5 illustrates a data process flow and architecture. Web server pages 800 are used to coordinate information as processed. The dynamically linked libraries 801 store information to be used by procedures 802. The SQL server database 803 provides the repository for the stored superset (or supersets).

FIG. 5 is described with respect to web server pages. It is appreciated that any system may be used to handle the input and output from the system. Web server pages are provided as an example, but not considered to be a limiting part of the invention.

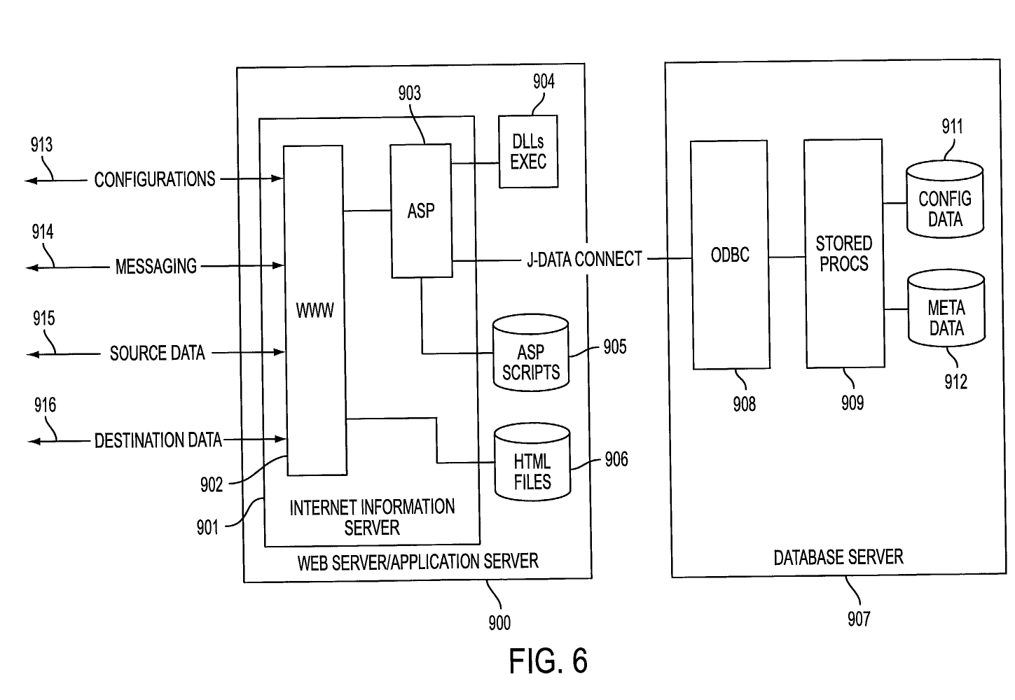

FIG. 6 shows an example of physical architecture. Other architectures may be used in conjunction with or replacing the elements shown in FIG. 6. FIG. 6 includes a web server/application server 900 with an Internet Information Server (IIS) 901. The IIS server 901 includes a www server 902 connected to an ASP server 903. The DLLs execution engine 904 is connected to the ASP server 903 as is a database housing ASP scripts 905. The www server is also connected to a database 906 housing HTML files.

The ASP server 903 is also connected through a J-Data Connector to ODBC 908 housed in database server 907. The ODBC 908 is connected to stored procedures 910 that access configuration data database 911 and meta data database 912.

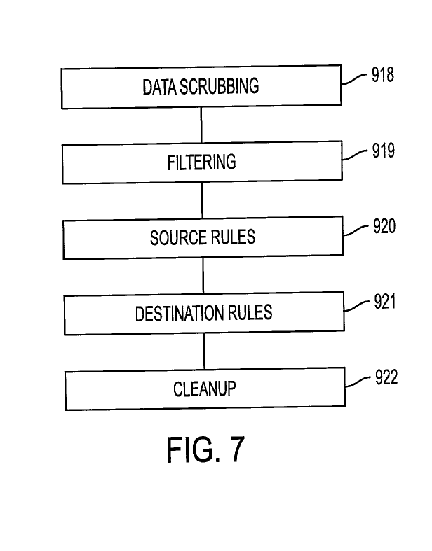

FIG. 7 shows a process flow for processing information. The steps include data scrubbing 918, filtering 919, application of source rules 920, application of destination rules 921 and a final clean up (or exception handling) 922. The steps of FIG. 7 may be rearranged as needed or to accommodate faster information processing. For example, rather than scrubbing data in step 918 prior to filtering in step 919, the data may have significant extraneous data that is better filtered out prior to scrubbing. This is one example. Other reordering are possible and considered within the scope of the invention. Further, some process steps of FIG. 7 may be eliminated. For example, filtering 918 may not be used if there is no information to be filtered out. Also, destination rules 921 may be eliminated if there is only one destination so all source rules would accommodate the destination rules as well. Similarly, with only one source, the source rules may also be eliminated, as the destination rules would accommodate all source/destination filtering.

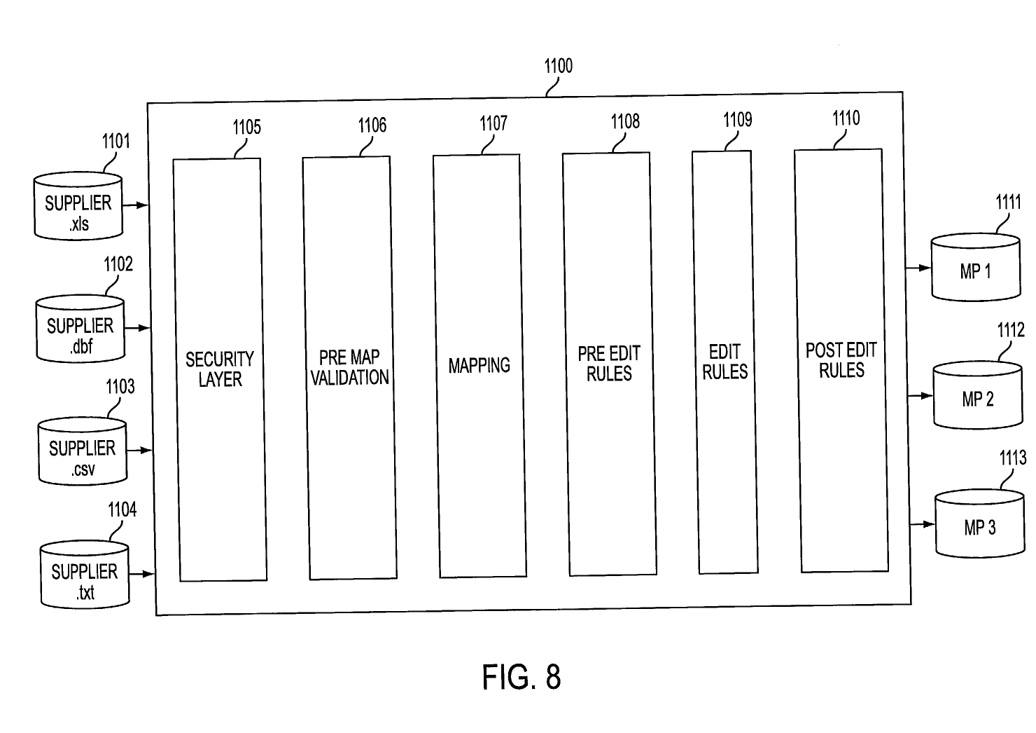

FIG. 8 shows a system flow architecture in which the system 1100 intercedes between suppliers 1101-1104 and recipients MP 1-3 1111-1113. Here, supplier 1101 forwards a spreadsheet (.xls) to system 1100. Supplier 1102 forwards a database (.dbf) to system 1100. Supplier 1103 forwards a comma separated value file (.csv) (using commas, tabs, and any other known delimiter to separate values) to system 1100. Supplier 1104 forwards a text file (.txt) to system 1100.

The system 1100 includes a security layer 1105, a pre-map validation layer 1106, a mapping layer 1107, a pre-edit rules layer 1108, and edit rules layer 1109 and a post edit rules layer 1110. Based on the desired course of information from the various suppliers, the information is forwarded to the various recipients MP 1-3 1111-1113. In one example, the recipients may be auction marketplaces. In other examples, the recipients may be publication houses (receiving formatted articles and stories from journalists). In a third example, the suppliers may be publishing houses providing information to electronic databases (for example, Lexis-Nexis, IEEE, and other companies with data warehouses).

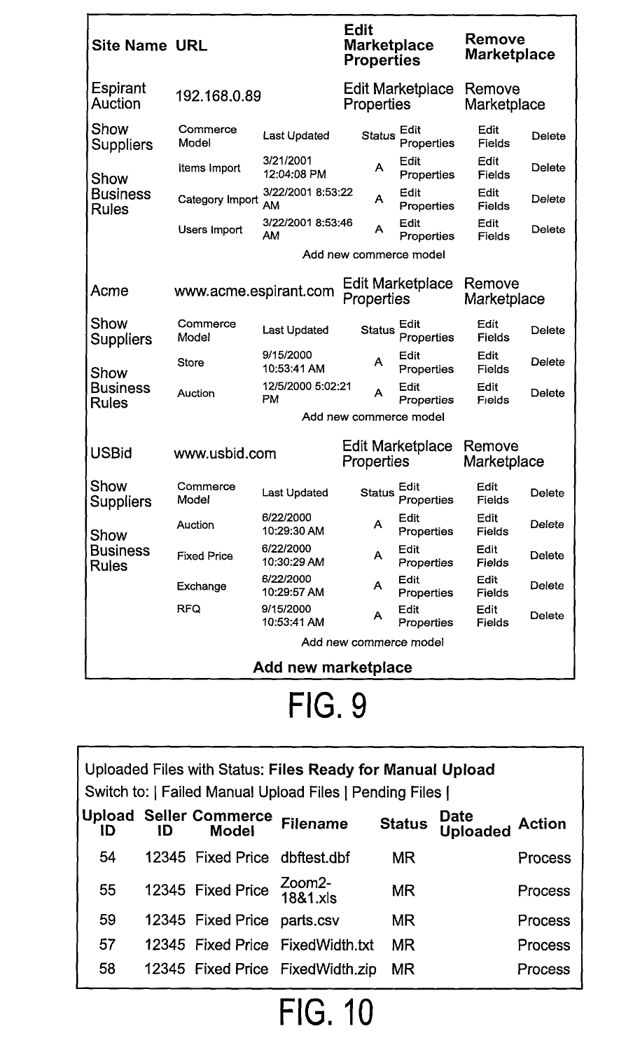

FIG. 9 shows a list of marketplaces and their various commerce models. The list of marketplaces includes Espirant Auction, Acme at Espirant.com and USBid. Each has a variety of commerce models including a store, an auction, fixed price dealing, an exchange and a RFQ. The user interface includes the time the system was last updated, the status of the update, the properties of the market, the fields associated with the marketplace and the ability to delete the marketplace from the system.

FIG. 10 shows a list of files ready to be uploaded to a marketplace. The list includes the upload ID of the file to be uploaded, the seller ID, the commerce model of the market, the file name to be uploaded, the status of the upload, the date uploaded and the action to performed.

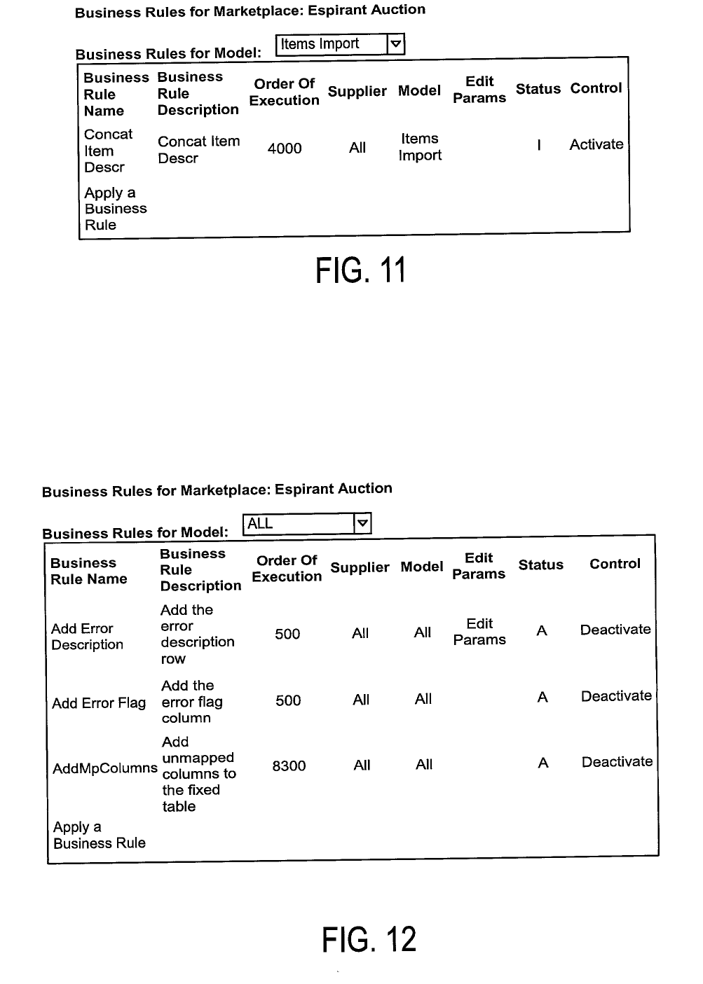

FIG. 11 shows a user interface for ordering a rules operation. The user is able to specify a commerce model and is shown a variety of business rules associated with the commerce model.

FIG. 12 shows a user interface for modifying business rules. The user specifies a business model to be shown and is provided a list of business rules and their status.

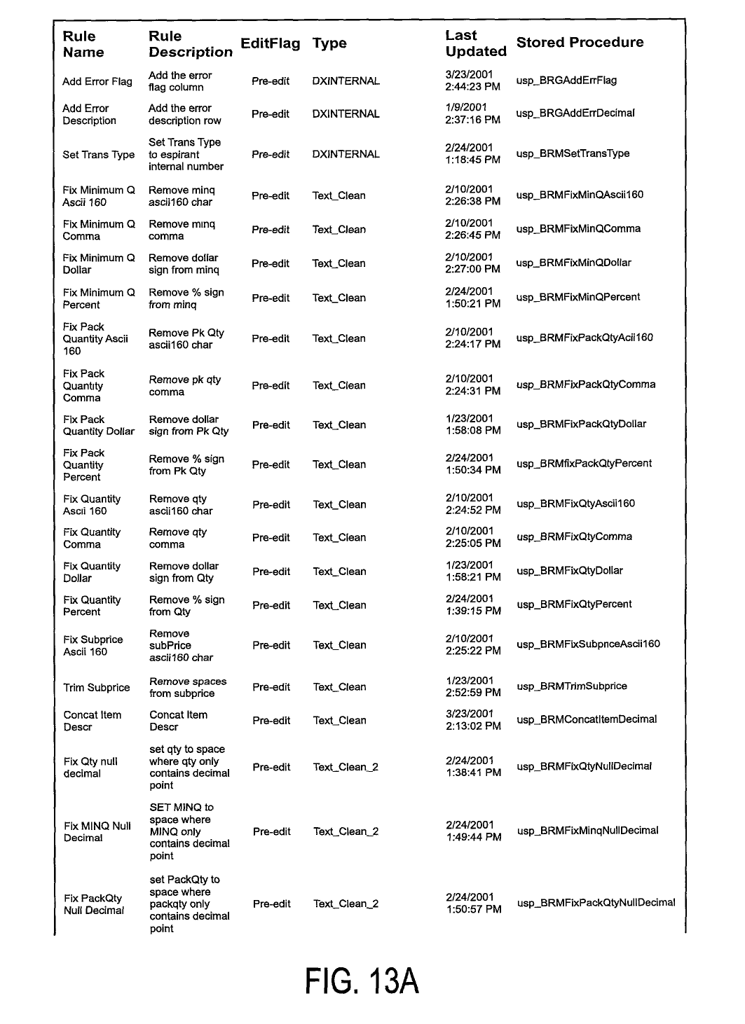

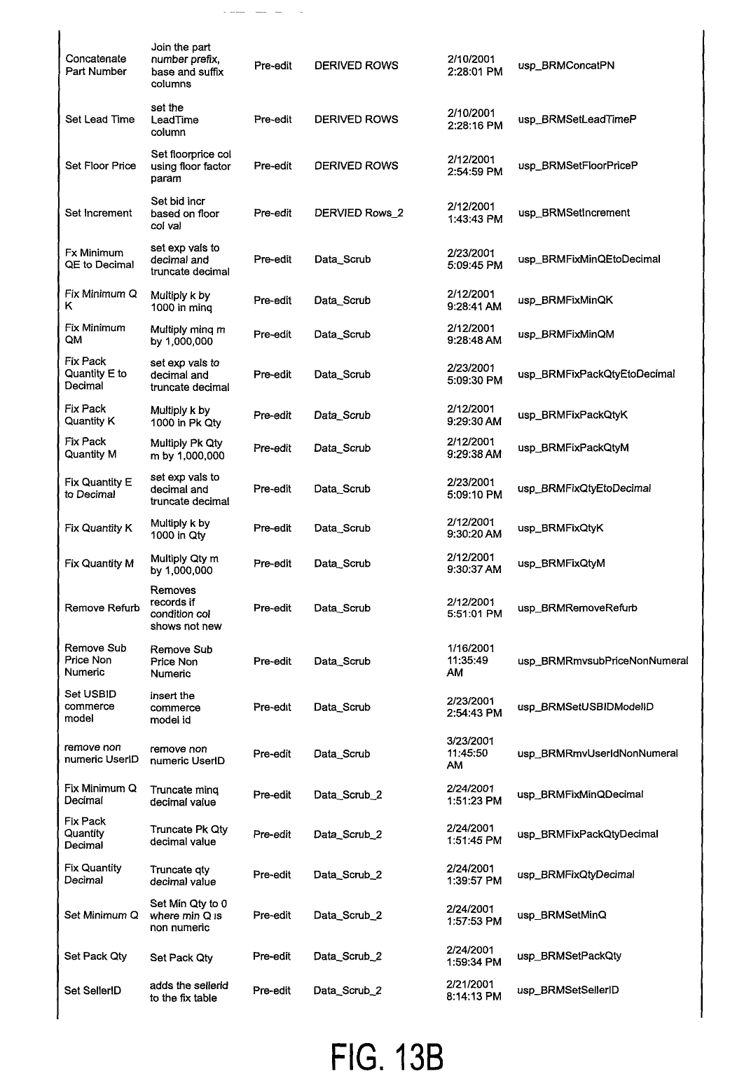

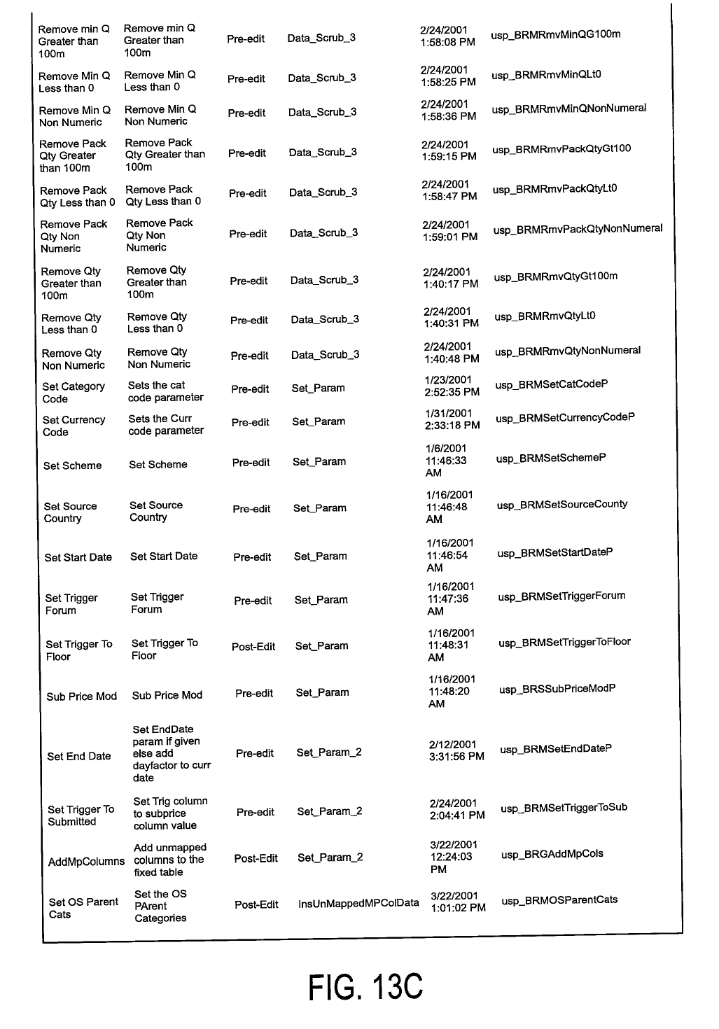

FIGS. 13A-13C show a list of business rules. The rules include a rule name, a rule description, an edit flag, the type of rule, the last update time and date, and the stored procedure identifier.

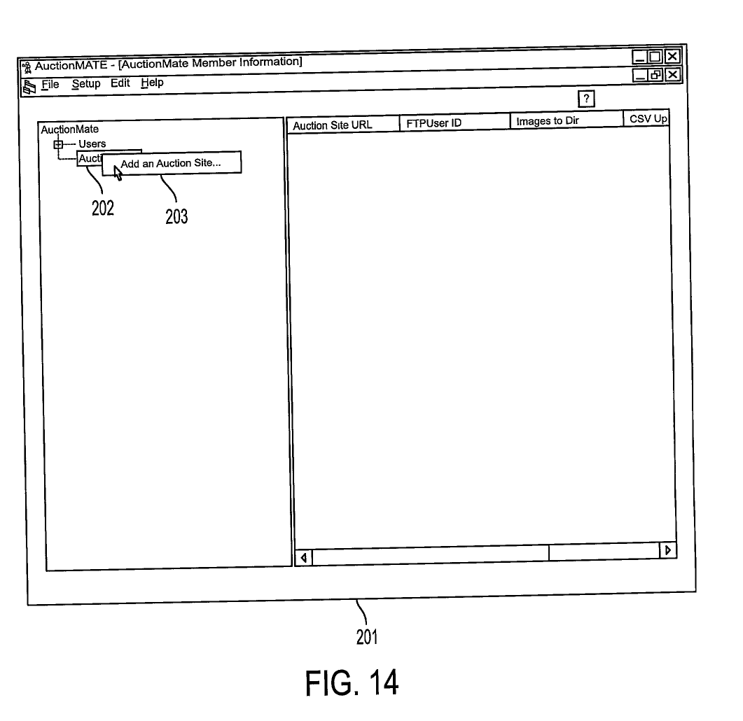

The following FIGS. 14-26 describe embodiments related to marketplaces. FIG. 14 shows an administrator selecting an option of adding a new marketplace to the system.

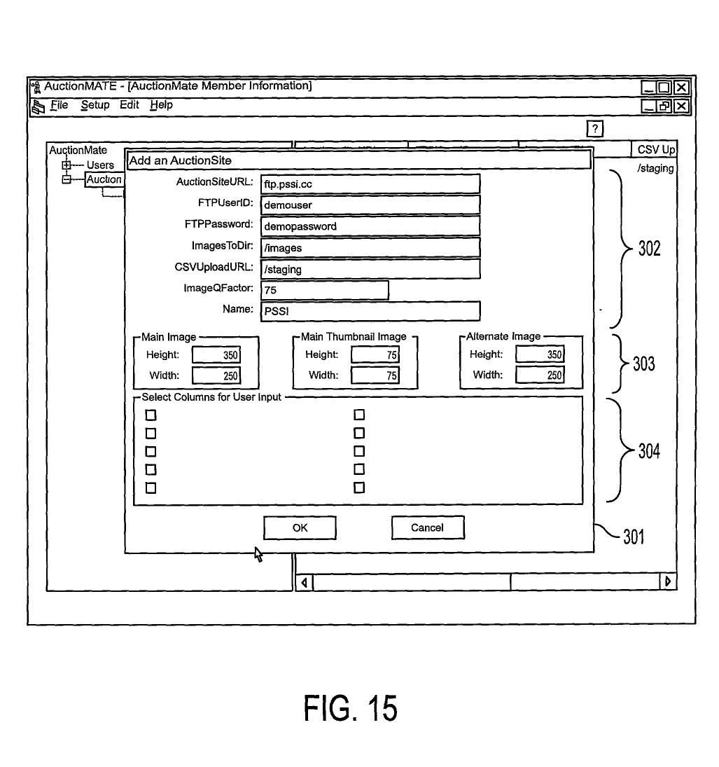

FIG. 15 shows a user interface receiving information relating to a new marketplace. Here, the location of the marketplace is at ftp.pssi.cc. Also specified in this user interface are size constraints 303 for received images. Specifying image size allows later added images to be automatically fitted to fit the image parameters required by the marketplace. Further, alternative image specifications are possible including the use of thumbnails and alternative images.

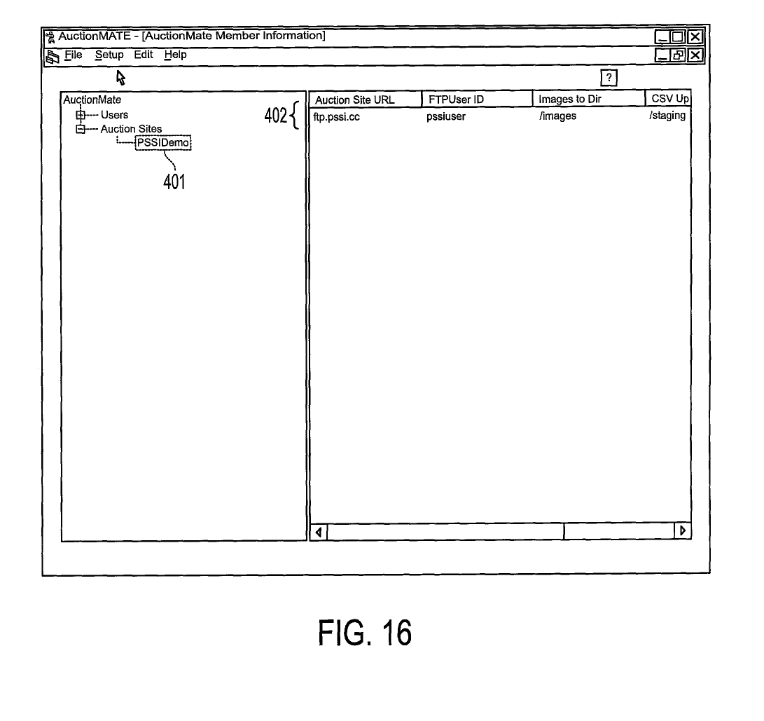

FIG. 16 shows a user interface showing the recognition of the PSSIDemo site. While the PSSIDemo site may have existed prior to populating the fields of FIG. 15, FIG. 16 shows the system having received information regarding the PSSIDemo site, enabling one to upload information to it.

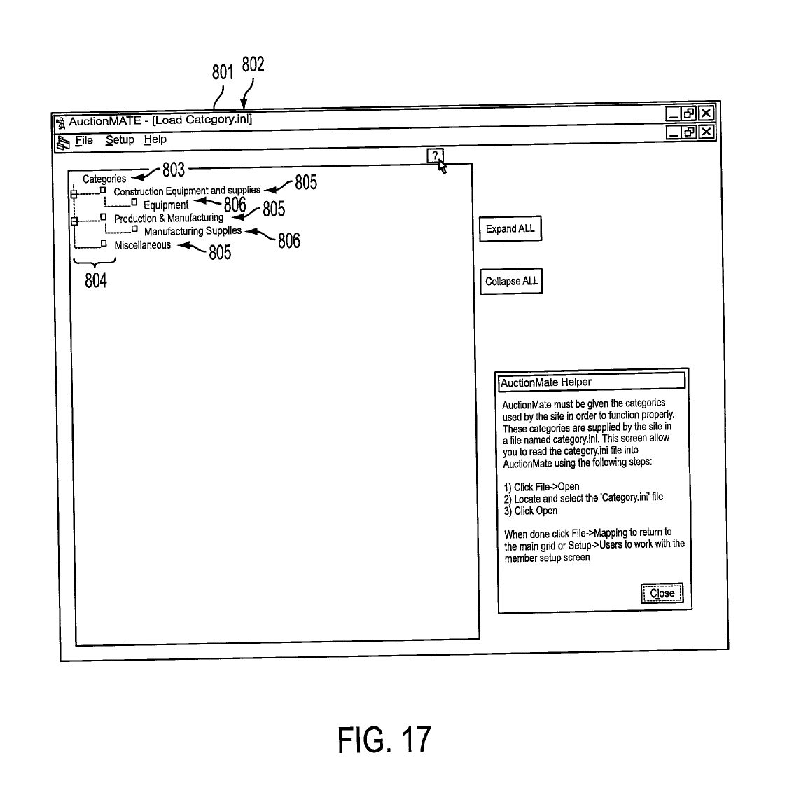

FIG. 17 shows a user interface with the categories from the category.ini file having been loaded. Specifically, the user interface portion shows categories 803 with expandable sub branches 804 as including construction equipment and supplies, production & manufacturing, and miscellaneous categories 805. A farther set of sub categories exist below sub categories 805 may also exist. Here, sub-sub-categories include equipment and manufacturing supplies 806. It is appreciated that further layers of subcategories may exist as is known in ontological classifications of categories and sub categories.

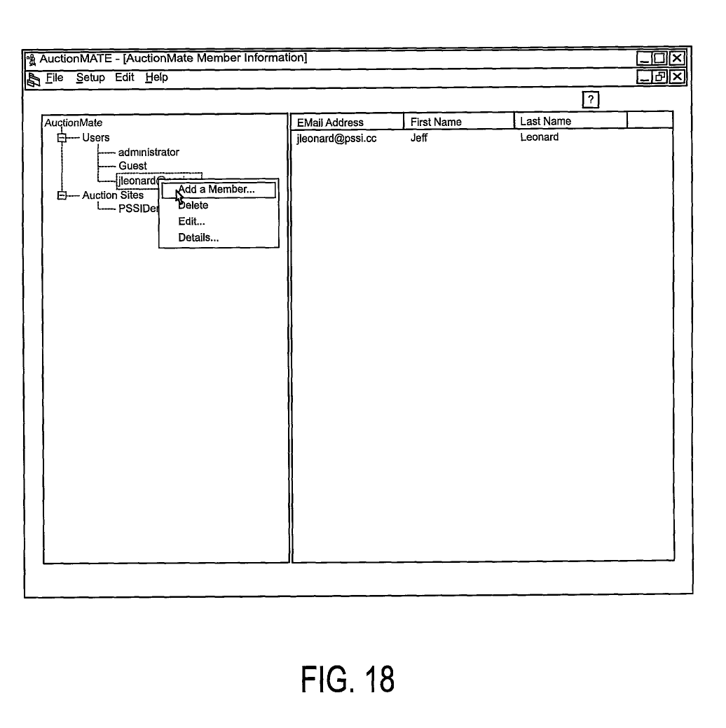

FIG. 18 shows a newly added member as resident in the system being added to affiliated with a user. Here, the user is jleonard@pssi.cc. The relationship between the user and member and marketplace may be as follows: the user provides information from the member to the marketplace. The user may be affiliated with the member, affiliated with the marketplace, or affiliated with both, or affiliated with neither.

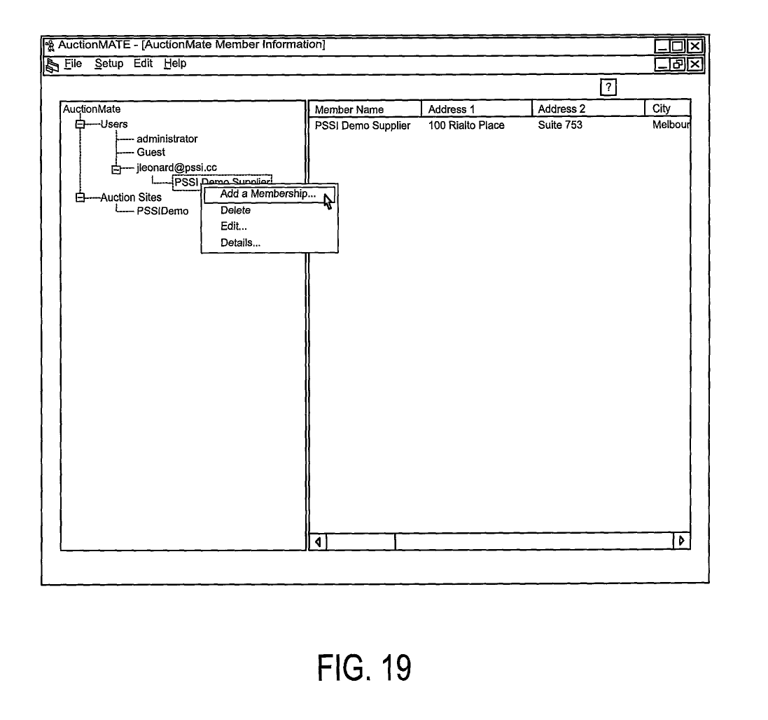

FIG. 19 shows an administrator selecting an option of add a membership to the member so as to permit access to a marketplace. By the fact that the member is nested under the user listing indicates that the user has access an ability to control the bulk uploading of information from the member to a marketplace. Here, for example, the member PSSIDemo Supplier is being managed by jleonard@pssi.cc.

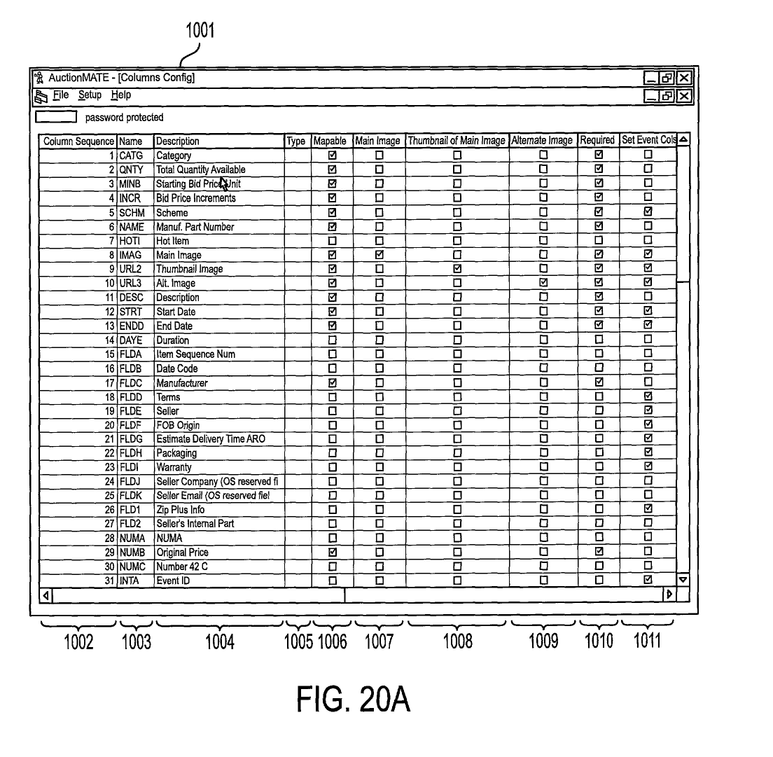

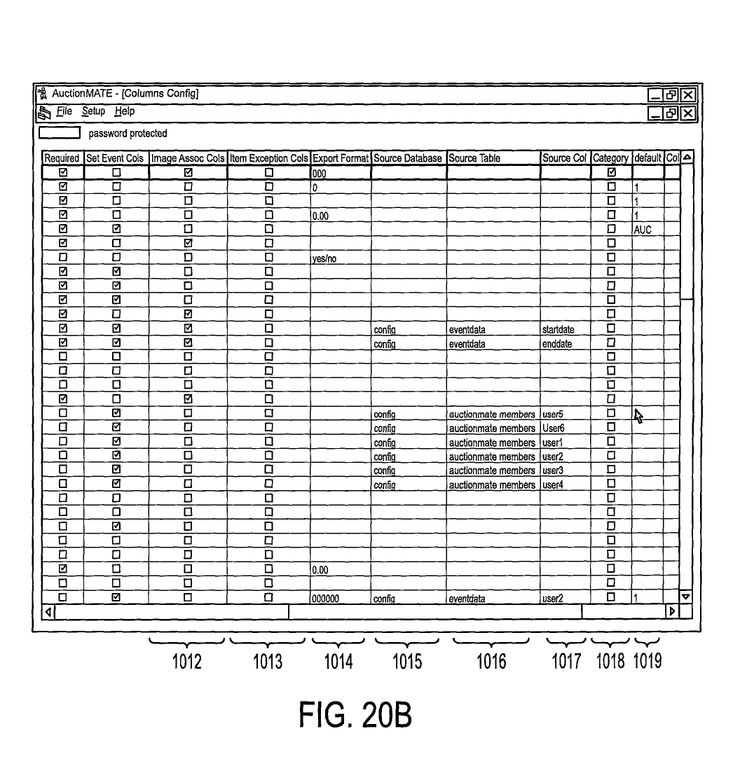

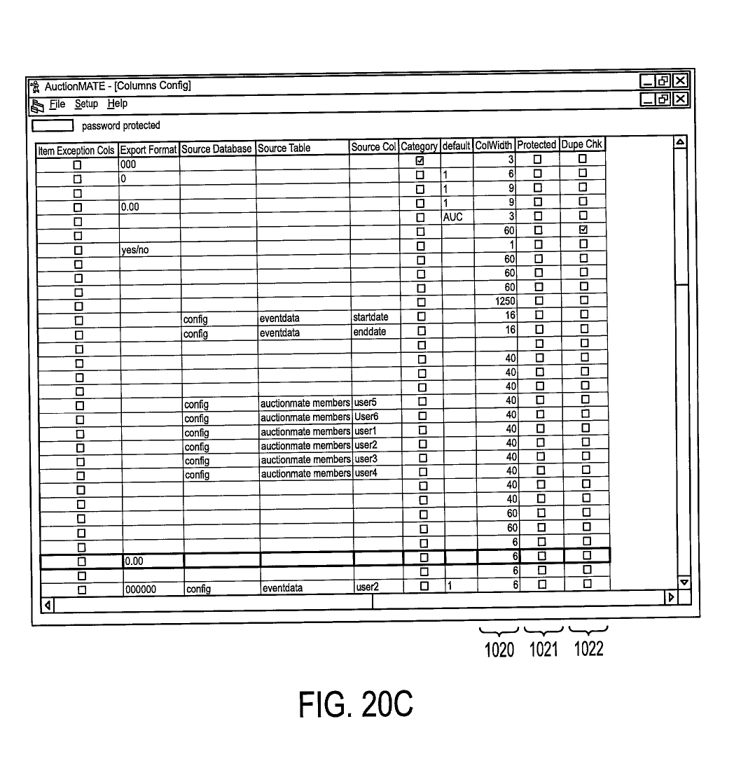

FIGS. 20A-20C show a user interface 1001 as including super set of columns and how those columns are used in a specific marketplace. Some of these columns comprise the columns available in the marketplace. For simplicity, the actual columns as shown in user interface 1001 are referred to as information sets or sets of information so as to eliminate confusion with the columns whose names are identified in 1003. Check boxes are shown to indicate what items are selected. However, other selection techniques may be used including radio buttons and the like. Further, where some choices are not applicable, the check boxes may be grayed out.

As shown in FIGS. 20A-20C, the sets of information in user interface include a listing of the names of the columns 1003, a description of the columns 1004, and a column sequence number 1002. The type information set 1005 provides a multiplicity of different options for the administrator to specify the way the particular item is sold in the marketplace. For example, it could be sold in a classified marketplace, in an auction, in a reverse auction and the like. It could be sold as a catalog item. The business rules check the item being posted as well as the rules of the marketplace to ensure the type chosen by the user is the type accepted by the marketplace. It also may provide a series of pull down windows overlays or other help modules that help guide the user to place his products in an appropriate marketplace and/or select an appropriate type depending on the type supported by the marketplace. The type may be selected to be any type supported by any marketplace on the Internet. The user may therefore select from a pull down menu or dialog box-type interface any of plurality of different types and therefore be directed to a particular marketplace. Alternatively, the user may be guided to the correct marketplace for the particular type of item, such as car, boat, porcelain, plates, etc. and then given the types supported by the marketplaces that typically carry the items the user wishes to sell.

One marketplace is a bid/ask/exchange marketplace. Here, the buyer may be able to offer certain terms on which he will buy the product and/or a seller may be able to offer certain terms under which he will sell the product. Another marketplace type includes a first right of refusal whereby various vendors are able to meet or exceed the terms offered by the offering party and other vendors may be able to post their own terms such that the preferred vendor may be able to log on and meet any terms offered by another party. Thus, a business could set up a marketplace where one service provider posts its initial terms and conditions on the website, then a series of other approved service providers could try to best the offer. The preferred service provider would have a first right of refusal on meeting any terms and conditions for service contracts. The system may also include services and types associated with the services and types of price models associated with the services. The mappable column in FIG. 20A provides a checkmark, which indicates to the user that the particular description of the goods in the row has already been mapped into the particular product category received by the marketplace. Where a checkmark is not present, it means the user has to go in and perform a manual mapping in order to place the goods in the correct columns in the correct categories for use in the marketplace.

Sets of information 1006 relate to what is mappable to a specific marketplace. If the user interface related to the marketplace of fip.pssi.cc, the marketplace would have columns including “category,” “total quantity available,” . . . and “manufacturer part number” (column sequence items 1-6) but would not contain reference to a “hot” item (column reference 7). In short, the mappable column 1006 represents a filter for a particular marketplace, which indicates the types of things for a selected marketplace, which may be mapped into that marketplace. For example, the marketplace selected by the particular administrators shown in FIG. 20A may not have the capability to map a warranty into a field of the marketplace. So the mappable column indicates from the superset of all possible descriptions shown in column 1002, 1002, 1004 labeled description which of the types of information about a particular item to be sold will map into the particular marketplace selected by the user. The list of descriptions of different categories is a superset of all category descriptions currently available for marketplaces on the Internet.

The user may update the category description items periodically by simply updating his software. He may log into a site and download additional descriptions for the marketplaces as they evolve over time. A subscription fee provides this update to a third party or other centralized location, which monitors all marketplaces and updates descriptions to correspond to those of an appropriate marketplace. The system may also have a plurality of mappable columns each one for a different marketplace, where the user may select particular items to map. Additionally, the mappable may include an asterisk or other indication such as color in the check box to indicate that the item being mapped is required.

In an alternative embodiment, a separate column is provided which indicates the minimum fields for a particular marketplace. This column may either be integrated into the mappable column and/or provided as a separate required column. The name column in FIG. 18 represents the marketplace fields. For example, IMAG in the marketplace is the first image that is mapped in the auctionmate system to a name such as main image to give a user-friendlier interface to the marketplace system. Additionally, URL2 and URL3 are mapped to a thumbnail image and an alternate image in the system to provide a user-friendlier interface for the user to understand and the definitions in the marketplace.

In the embodiments shown in FIG. 20A, there are a plurality of additional columns such as a main image thumbnail and an alternate image which the user may select to indicate that the main image field may be or is to be mapped into the marketplace. One example would be where the user checks the field and a pull-down menu arrives allowing a user to map the image to various locations in the marketplace. For example, as the administrator checks “map main image”, a screen shot of the marketplace may appear in a dialog box with various areas highlighted in red and/or alternating blinking videos such that the user may map the main image into various locations in the particular marketplace which she is working on at the moment. In this manner, the administrator may map either the main, alternate, or thumbnail image into various locations to the marketplace by simply identifying the particular areas on the marketplace for the image to arrive. In alternative embodiments, the administrator may map a plurality of images into one place on the marketplace and have the images alternate such that as the viewer is looking at the particular item in the marketplace.

Also, by setting the existence of some categories and not others, the administrator minimizes the chance of a user experiencing errors by limiting the capabilities of the users to fixed bounds.

Information set 1010 specifies which columns are required to be mapped by a user. The set events column 1011 allows the administrator to specify when events occur. For example, a user may specify that the start date of a sale in a marketplace be defined by the information contained in a “start date” column (STRT). This set events information set may also specify what information should be provided on an on-line marketplace. For example, other information might include an event ID, warranty, packaging, estimated delivery time, FOB, seller terms, start date, end date, images, and the particular bid price increments.

In a particular marketplace currently selected in the administrator, there may be a variety of events in addition to the auction on-line auction. For example the on-line auction maybe followed by a live auction, which has certain terms and conditions that apply. If the marketplace is a two-stage marketplace having an on-line auction followed by a live auction certain categories of terms and conditions and events are mapped from the superset of all parameters into those supported by the live auction that may in fact be different from the events supported by the electronic auction. Thus, the terms and conditions need to be set for multiple iterations of the auction. In other embodiments, a first set of terms may be specified for selecting a smaller set of bidders and a second set of terms may be selected for the best and final bidders. Other permutations may also be available.

The additional set of information of 1011 may be important if the type of action shifts from on-line to live, as the terms are part of the event. The terms of the auction shift as the auction shifts. If there were an on-line auction only, the item for sale would be immediately purchased once the on-line auction is closed. But in the instance where there is a live auction to follow, the terms would be different. The on-line auction bid would be included in the live auction. Alternatively, it would be kept secret in the live auction and later compared with the resulting bid of the live auction.

The image association information set 1012 indicates which items descriptors have images associated with them. For example, the category of goods may have a general image that indicates a particular category such as tools, produce, cars, boats, or other type of category. The particular manufacturer may have a symbol such as Maytag, Westinghouse, Ford, Grady White or other manufacturer logo or symbol known to identify the particular product being auctioned. Thus, the alternate image column provides an indication of whether an image may be associated with the particular descriptive item in the superset. Uses of these description items may, for example, be provided such that a user may scan down a list of boats for sale, looking for boats belonging to Boston Whaler or all cars belonging to Ford.

The item exception information set 1013 indicates whether the particular marketplace has one or a plurality of business rules, which may be applied to the item in order to, map the item to the marketplace. The user may view the business rules and/or certain exceptions may be allowed for certain business rules. For example, although the business rule may require an image for a particular category of goods such as produce, the administrator may map a standard image of produce to that particular category of goods. Thus, this provides an exception to a mandatory field. Other fields, which may be mandatory, may similarly be mapped with a static or a standard response which is not necessarily indicative of information provided by the business placing the goods on the market.

The export format 1014 may be presented as a column form and/or a dialog box form which, for a particular marketplace, allows the user to specify certain export formats and/or control the export of the data and/or the import of the data into the marketplace such that for example, the user may specify an item as being a “hot” item. The user may also specify an item as being an favorite item where the marketplace would give the item additional placement and/or marketing coverage for a select fee. Other options may include, importing the item into a particular category of forced importation. Further, the administrator may specify the particular date formats, monetary formats, monetary currency, and other items of interest. For example, if the marketplace is in Singapore, the user may select that an offers must be in U.S. dollars. The export format may in fact provide a plurality of different exports for different marketplaces. For example, the owner of a plurality of goods such as semiconductor devices must place the devices for sale on a U.S. market and also may place the devices for sale on a corresponding foreign market. The foreign market may be in a different language from than the U.S. market and a different currency.

The system may also include a module which monitors each of the different marketplaces, records the bids being made on that marketplace, and updates a different marketplace with the current minimum bid corresponding to the bid received on a separate marketplace. This source database indicates the configuration and/or location of the source data being imported for a particular set of parameters. For example, the item description, the terms and conditions may come from standard database supplied by the system, the images may come from a database maintained on a image server of the user, and the item descriptions may come out of an Excel spreadsheet, or the limited database and a third location and/or third server. The source database column provides the flexibility to draw from a plurality of sources within the particular business providing the data in order to provide the correct information into the system. The source table column represents the particular field and/or items in the source database to select for a particular item. For example, the particular item or the particular database may be an Excel database located on server X, the source table indicates that within the Excel database your looking for a particular table or groups of tables and the source column indicates the particular column in the table where the data is pulled from column and/or entry.

The category column picks the particular item from the superset of all items to be used to designate the category. For example, the superset of items may have a plurality of different categories and/or description items and the particular category and/or description item that is to be mapped into the marketplaces selected by a checkmark in the category column. The category column may have one or a plurality of different marks where, for example, the marketplace supports a tree-like hierarchy for categories such as automobiles, sports utility vehicles, Jeep, Jeep Grand Cherokee and a particular option configuration for that vehicle product.

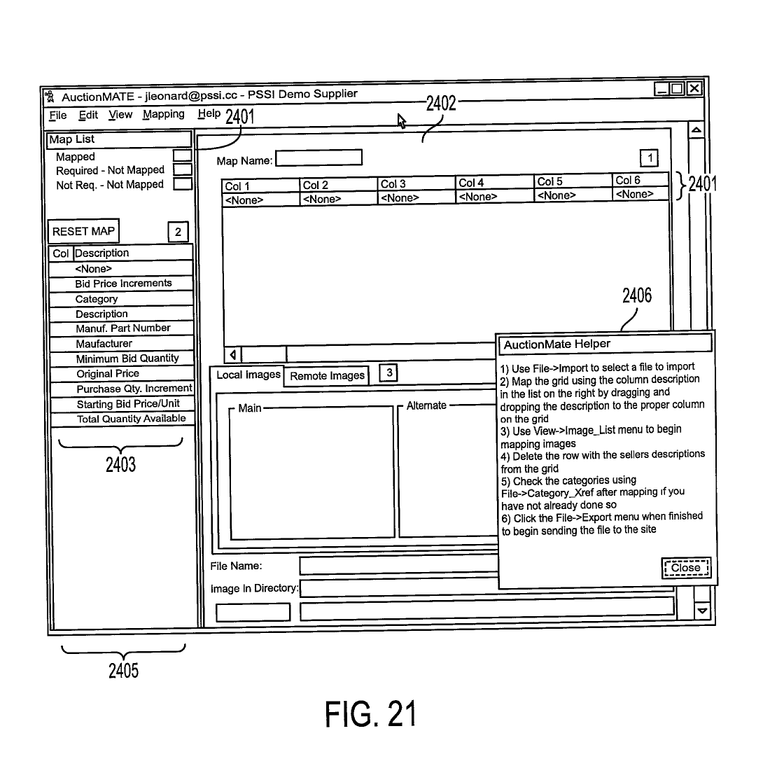

As shown in FIG. 21, the images may rotate as well to provide alternative images for the viewers. The alternative images are able to be associated with an item or service in FIG. 21. Other embodiments would allow the user to scroll through different images or to see a plurality of images depending on the configuration of the marketplace. The shown interface of the system is to provide a universal interface for administrators at companies for placing items on a plurality of different marketplaces. For example, the administrator may see a consistent screen from the system that enables the administrator to use, enter, manipulate and provide his data into a universal module. The user may then map his data to a particular marketplace using a spreadsheet and/or graphical interface where the graphical interfaces is used and/or spreadsheet, the system may present the user a previous screen of how the individual item is to be mapped in the marketplace. For example, the screen would imitate how the data would look after the data is mapped in the marketplace and allow the user to control moving images and/or selecting which images are displayed in the marketplace and which images are linked in the URL the placement of images within the marketplace and the mapping of his particular columns into the particular fields of the marketplace. All of these items are also preconditioned and configured in accordance with the rules done in the system to make sure that the items import seamlessly into the marketplace selected by the administrator. The technology in the present application allows a business-to-business transaction for bulk upload, whereby a user may see how his products, services and other items being displayed on the marketplace will look once on the marketplace. A preview or how the items is mapped and rendered in a particular marketplace.

A marketplace may have a plurality of different defaults and/or default terms, default conditions, and default quantities. The mapping system may by selecting a particular default value incorporate this into the transformation of the data from the system into the marketplace. The default value is represented in information set 1019. Thus, the system may select a plurality of different default values that get mapped into the marketplace. For certain categories there is a default such that if you don't designate it the system will assume the upload format is in an auction format. Or any other default associated with the particular marketplace. The example is auction although there are number of other defaults associated with the other descriptors. The column width column, this is an indication of the particular format that the marketplace supports. For example, the column width may indicate the width of a particular textural association with an image, a text description, and/or the column width of the maximum column width associated with the particular descriptive items. For example, the description of each of the images is limited to 60 characters whereas the description of the overall item is limited to 1250 characters.

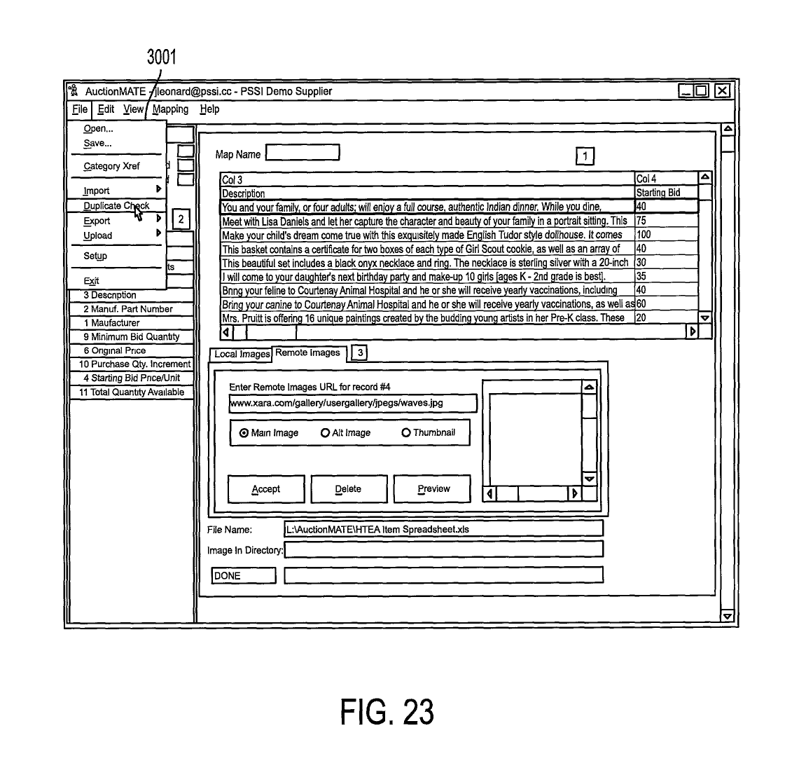

As shown in FIG. 23, duplicate checks may be performed by selection 3001. The duplicate check information set 1022 may allow the user certain control over identifying duplicate entries into a marketplace. For example, only one item such as manufacturer or part number may be checked. Alternatively, different items such as manufacturer part number, color description and/or a specific category may be checked which enables the administrator of the particular items to have additional control over his duplicate checking. The protected column provides a security overlay, which the administrator may prevent, any users from altering mappings of a particular field or fields. For example, once the user sets up the import of data into the marketplace selecting the particular terms and conditions, the particular user of the system within the organization such as a buyer or contract administrator may not therefore go in and modify the terms and conditions without getting consent from the administrator. This provides a multi-level security kernel for the software allowing different individuals within the seller's organization to have different control over the particular terms and conditions of a sale. For example, a buyer or contract administrator may not offer certain semiconductor chips baring a certain part number at a price either above or below a certain predetermined initial offering configuration set by the administrator.

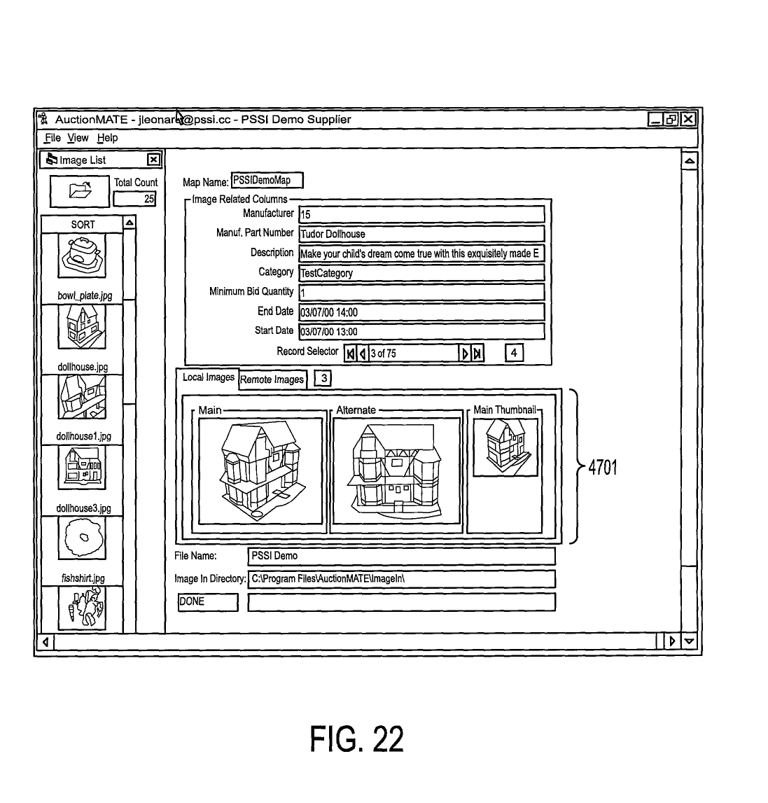

FIG. 22 illustrates a mapping process where the descriptions at the left are being dragged and dropped on particular column headings to map the data to the columns or the particular descriptions supported by the marketplace. An alternative embodiment is a pull-down window at the top of the column whereby the user may select the appropriate descriptions from the column headings and apply them in a pull-down window. Alternative embodiments may analyze the data and propose a particular column heading such that when the user clicks on the top of column 2 it would indicate item as being highlighted and the user may select a different column or may simply press enter to select item. Further, one may individually edit the content of an entry to improve data handling.

Additionally, standard values may be set for all items in the category as well as standard terms and conditions, standard start-time, standard stop-time, etc. This may be chosen from a pull-down pick menu and/or entered using editing capabilities. In addition to images, the auction may also support having the user dictate into a .wav file or other appropriate format, such as reel player, a audio description of the goods and/or walking the user through the various views and/or advantages or disadvantages and history of the goods using an audio file. Audio and/or video file. Thus, a user may provide an audio or a video of the item to be auctioned and then narrate the film in a .wav file to be associated with the video file. The system may link to a series of video/audio editing tools whereby the user may cut and paste different frames from the video and associate different audio with the video such that the editing function is simplified. These tools may be integrated directly into and/or provided as ancillary link to the tools.

The duplicate check may be used by a particular user uploading data which the check would be done just on the current data or it may be expanded and done not only on the current data being uploaded but also on existing data currently in the marketplace by the same supplier for the same products. In this manner, the individual user's and suppliers may be ensured that the data being posted is consistent with the existing data in the marketplace from that same supplier and may also view similar products from other suppliers so selected. In alternate embodiments, the user may select then indication, which informs the users of all duplicate parts currently being offered in all marketplaces supported by system. In this manner, the user may check the terms and conditions price quantity, bid, value sold price of all products currently being auctioned for the similar products. The user may either delay the bid for a certain period of time and set a predetermined threshold for bringing the bid back up at a later time such as two weeks or a month and/or the user may choose to import certain terms and/or conditions from one of the other sites selected. In various embodiments, the spreadsheet may be saved at any time and/or partially completed anywhere in the process. The spreadsheet indicates and/or recalls the point in the import process and decision tree implementation in which it left off and brings the user back to the point where he left off when he reenters the system. The category cross-reference ensures the input item descriptors and the categories in which they are associated with can be associated with a particular category in the marketplace.

Once finished, a map regarding the current set of labels may be stored to automate future file handlings.

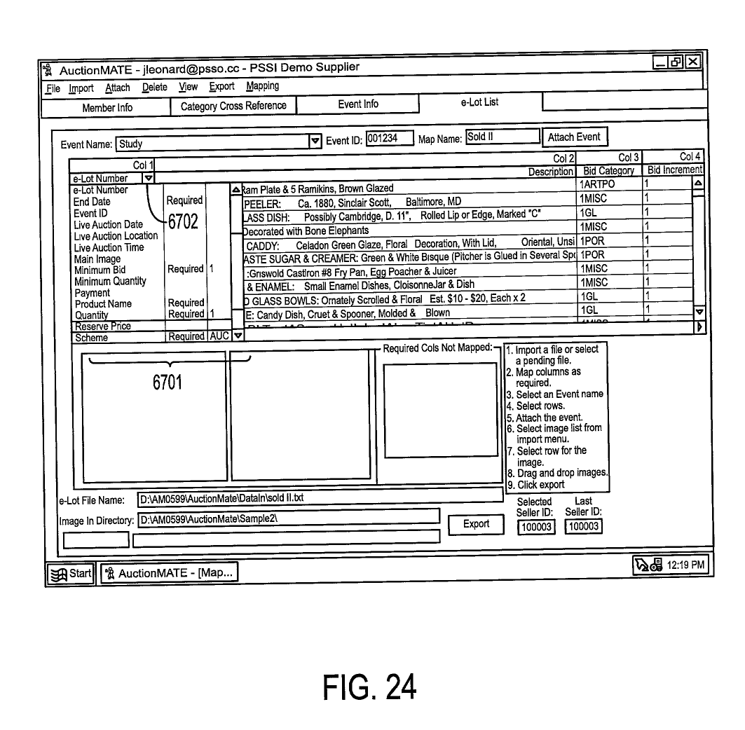

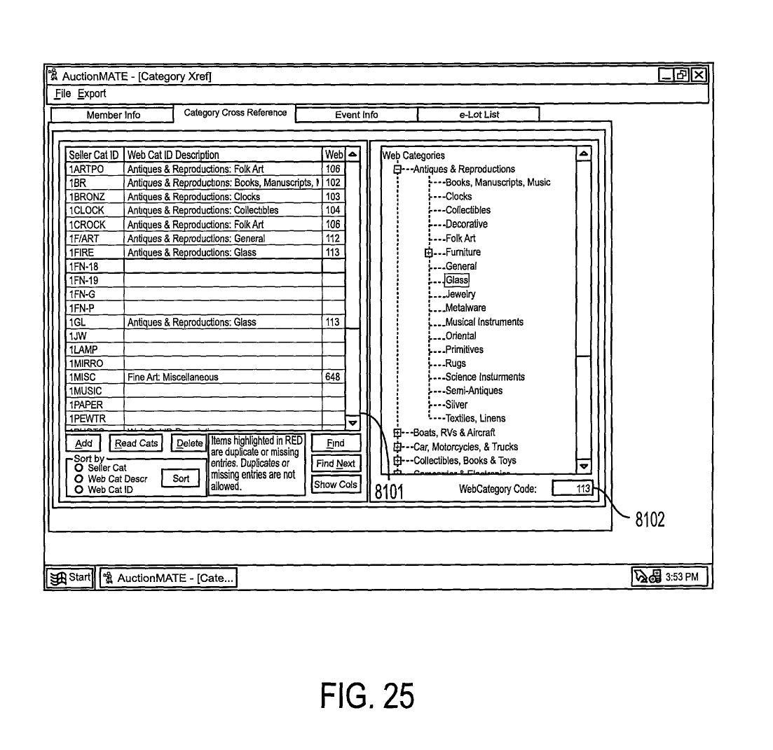

Referring to FIGS. 24 and 25, the marketplace categories are on the left and the seller categories are on the right. FIGS. 24 and 25 shows a drag and drop mapping for mapping the seller categories to the site categories. For mapping the marketplace categories on the left to the seller categories on the right. This provides a simplified manner in which the site categories and the seller categories may be cross-referenced with each other. The user may visually indicate which seller categories get associated with which site categories. The users sellers categories may get mapped into the site categories automatically and/or the user may be given the preferred mapping and allowed to change the mapping by simply dragging and dropping different mapping into his seller category list. These associations may be saved for future reference. The storage results in a knowledgebase which increases over time as the user imports different items from his sellers category and maps them to the site category or marketplace category the system remembers which seller categories map to which site categories and provides the mapping in the site category ID description.

In this manner, once the user has mapped the various categories, the map is displayed in the seller category listing as a preferred and remembered category mapping. The user may alter this mapping as, for example, the site categories are updated. The site categories may be updated either via update of the system or, more preferably, through a dynamic link to the system site which continually updates all site categories for a particular seller or marketplace. Thus, if the site categories are updated, the system may highlight the new categories and put a graphical and/or numeric indication next to the new category indicated it as being “new”. Thus, the seller may scan down the site categories, identify the new categories and map his products into the new category. For example, the new category may be semiconductor ICs. Then the seller may be able to map his semiconductor ICs into the site categories of semiconductor ICs from the previous mapping of miscellaneous. In this category cross-reference, sites may delete various categories and thus, these categories become non-selectable. Where a site category becomes non-selectable, it is marked in the sellers categories such that the mapping is indicated as being no longer being valid. Thus, for example, where the site category was “production and manufacturing,” the new site category may be individual items within “production and manufacturing.” Thus, the prior site category ID description is no longer valid and is marked as being not selectable. The user may then recross-reference the seller category ID to the site category that are currently available by simply recompleting the cross-reference mapping. The system also provides a knowledgebase whereby as a category in the auction system becomes no longer available it provides the most common sense mapping as a proposal from a pull-down list which may activated by clicking on the obsolete site category ID description from the list on the right under the seller categories. This embodiment may include auto-sizing features that conform the images to the specifications of the marketplace. Additionally, the image mapping may be done such that a particular manufacturing model number that has been mapped to a particular image in the past is automatically selected in a pick list as the image for mapping in the current product. Additionally, where the images are stored under a model number, the system may automatically pre-select the image having the model number of the product as the selected image. This helps facilitate the operator's mapping images to the particular items offered for auction. The image may be provided either in a vertical menu on the left of the image screen and/or in a plurality of thumbnail images occupying the entire bottom of the screen. Alternatively, where multiple monitors are hooked up to the computer, the thumbnail images may appear on the left-hand monitor and may be dragged and dropped to the right-hand monitor in the system. This allows the individual user to view all of the potential images and select the various images for the particular item to be selected. Dragging a particular image into the system also imports the particular description associated with that image and any video files associated with the image and/or audio files. Thus, where a user selects a particular image and/or imports a particular image all of the additional files that are tagged such as thumbnails may alternate image which .wav files jpg files, video files (and the like) are also imported for the particular item. Thus, a subsidiary system may provide for videotape import, digital camera import, .wav file import and scanning of product literature into a database. This database, in its entirety, may then be edited in an image editing software in imported by simply clicking on the jpg image of the catalog header for all descriptive material associated with that item. The system, also, may offer a plurality of pre-defined images associated with particular products. For example, in the used car market, the system may provide several hundred or thousand images audio and/or video files associated with a particular automobile type, class and options. Thus, a user who is importing various files and/or graphic files may select from a predetermined set of images that are matched to the particular make or model number normally associated with that automobile. In this manner, a used car dealership or boat dealership need not go out and create its own audio/video files for each individual boat but may use representative samples supplied by the system. Additional services offered by the system are to assign an individual to a corporation that travels to the corporate location and collects audio/visual information on the various products and/or inventory offered by the company. This audio/visual information is stored in a CD and/or DVD ROM by the system to then supply the information to the individual seller and/or supplier that may thereafter associate the audio/visual information with its various products as it uploads it to the marketplace.

A preview function may also be available. For viewing the image file as it will be rendered, one may connect using a local area network, a modem and/or the Internet to a remote image server of the user select the image, import the image, resize the image in accordance with the marketplace parameters and prepare the image to be posted to the marketplace. The system may retrieve the parameters of the marketplace and create a mocked-up version of a sample display as including the specified images and text. This way one would be assured of proper image handling and presentation of the item for sale.

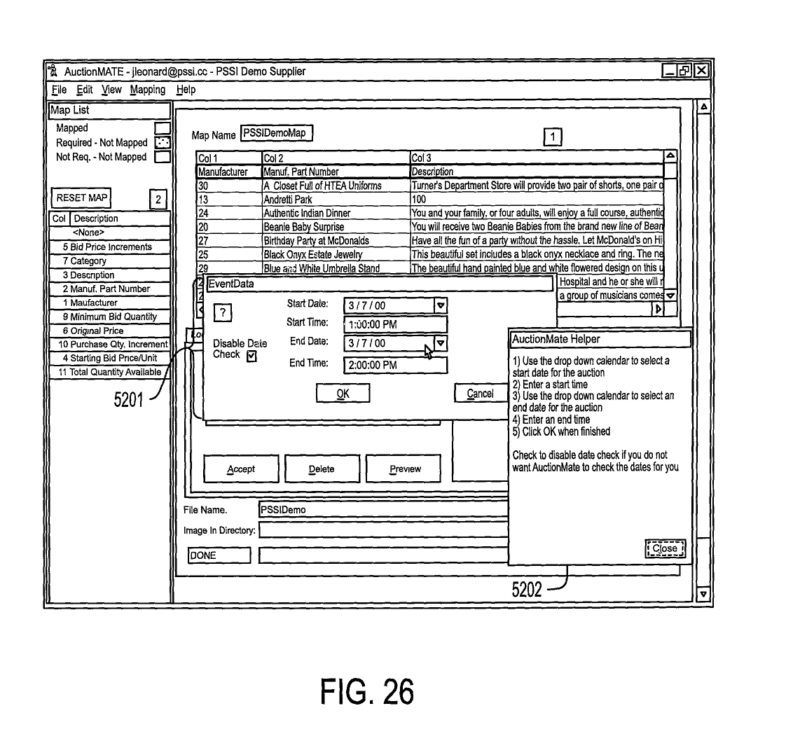

As shown in FIG. 26, the loading system may also incorporate a drop down calendar for having the supplier select auction start date, auction end date. In selecting the calendar, the system may identify equivalent items offered in the current marketplace and/or other marketplace that correspond to the selected item the supplier is placing for bid. Thus, the supplier may in viewing the calendar alter the start-time and/or stop-time of his particular auction based on other items currently being offered for sale in the marketplace.

One particular problem with the bulk upload process is the huge amount of information that is transferred to the marketplace on a particular implementation. For example, where the supplier is offering a 1,000 different items each associated with the five to ten images and descriptions as well associated audio and video files, depending on the speed of the suppliers link which, in certain instances, maybe as slow as 56 kilobytes and/or 128 kilobytes DSL line, the image upload process may take a significant time. Thus, the user is sitting watching an upload screen and become aware that his product is not actually being uploaded as quickly as he might have anticipated. In order to reduce the amount of user anxiety, the upload screen shows the images are they are being uploaded as well as the associated files to allow the individual to feel that the progression of his upload from his auction system is progressing at a higher speed than what he might have felt had the images and/or associated files not been shown. In various embodiments, the system may allow the user to upload data directly to the particular marketplace. However, in these embodiments, it may be that the marketplace changes and/or the user's system is not current. As an alternative embodiment, the user may upload his data to the third party site which then forwards the information to the marketplace. Thus, the third party may control the loading of the data into the marketplace and have a sophisticated operator to handle any changes in the marketplace and/or problems that may occur during the upload process. The service of interfacing between the supplier and the marketplace may be provided via a chart to the marketplace and/or the supplier. In this manner, the post site and associated operators may ensure the successful importation of the suppliers data into the marketplace. The auction demo site item upload operator may then notify the supplier and/or marketplace that the transfer was made successfully. The system may frame the marketplace and then provide indications to the user that the marketplace upload was completed successfully.

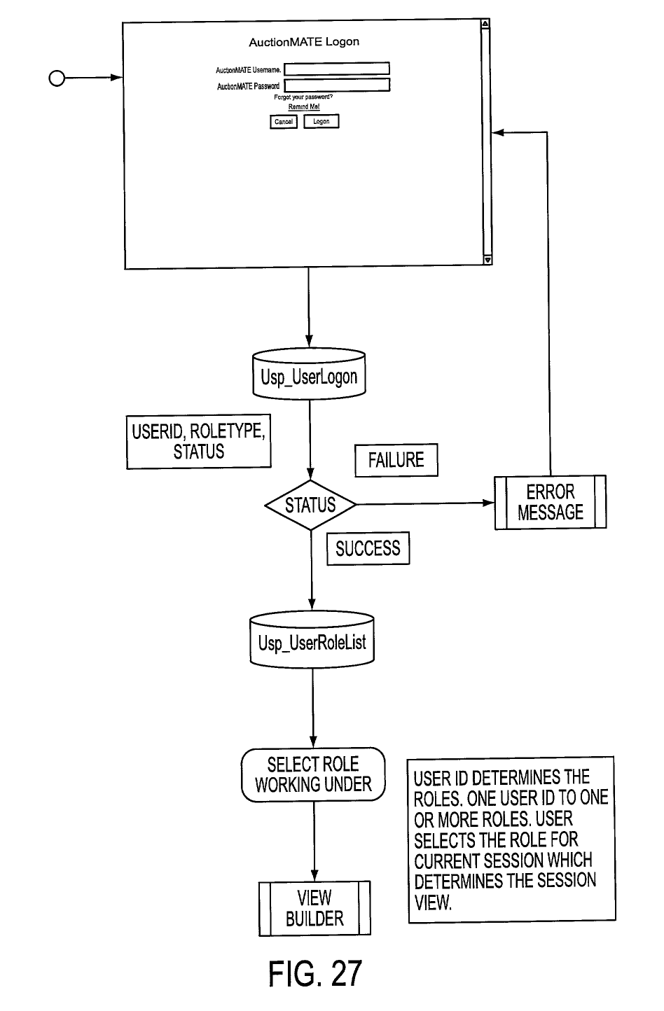

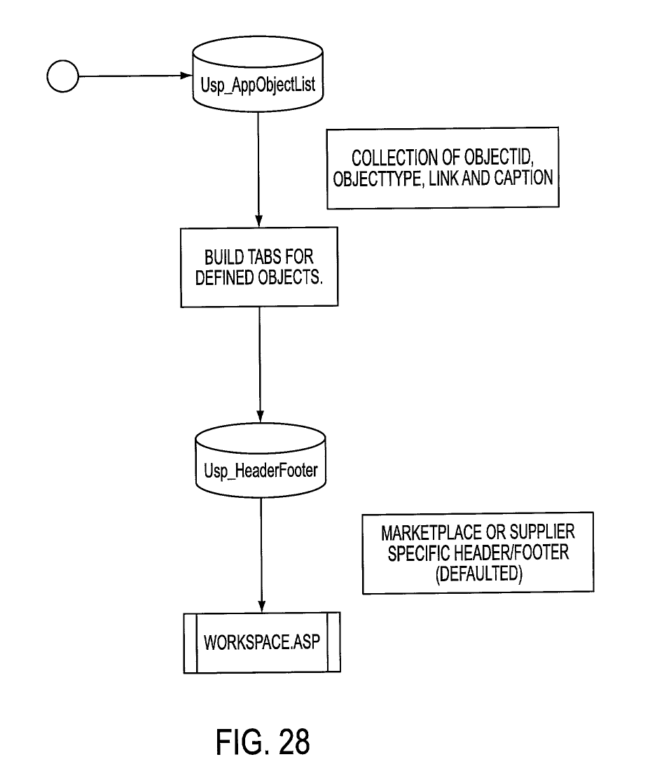

FIG. 27 and 28 show processes for a user to log into and use the system to process files for processing for a marketplace. The user provides an email and password for validation {Usp UserLogon.sq1}.

New users to complete the registration process prior to gaining access to the system. The data is collected from the user and entered into the database. The assignment of the approved roles for the user is an off-line process performed by the administrator. New users are approved for a Guest Role, which allows them access to a tour of the service and demo access to the Inventory Management workspace. The administrator approves the registration and allocate the corresponding roles for the new user. An email is sent to the user when approval process is complete.

Should the user forget their password, the ‘Remind Me!’ link can be activated. The user provides their email address and their password is retrieved from the database. The password is then forwarded onto the user using the database email address.

On success logon, the list of roles assigned to this user is retrieved from the database {Usp UserRoleList.sq1}. If more than one role is assigned, the user selects the role they are performing during this session. Depending on the role type selected, the user is prompted to select a marketplace and supplier id where applicable. The specifics for the user environment is described in the User Environment section. Using the roletype, the list of application objects is retrieved for that roletype. The session view is built from list of application objects.

Using the role type selected by the user, retrieve the list of application objects. Contained in this recordset is the link and caption to be activated for each application object. The marketplace id is used to determine the header and footers to be used in the presentation. If none are provided by the defined marketplace, a default header/footer set is used. At this point, the user has been authenticated, the role has been identified and is driving the presentation to the user.

The Report Generator workspace allows the user to generate various reports. The list of those available reports includes Crystal reports and other reports as are known in the art.

The Personal & Preferences workspace allows the user to update their user specific information including passwords and contact information. The user can also set preferences that govern response options regarding status of the data cleansing or upload information.

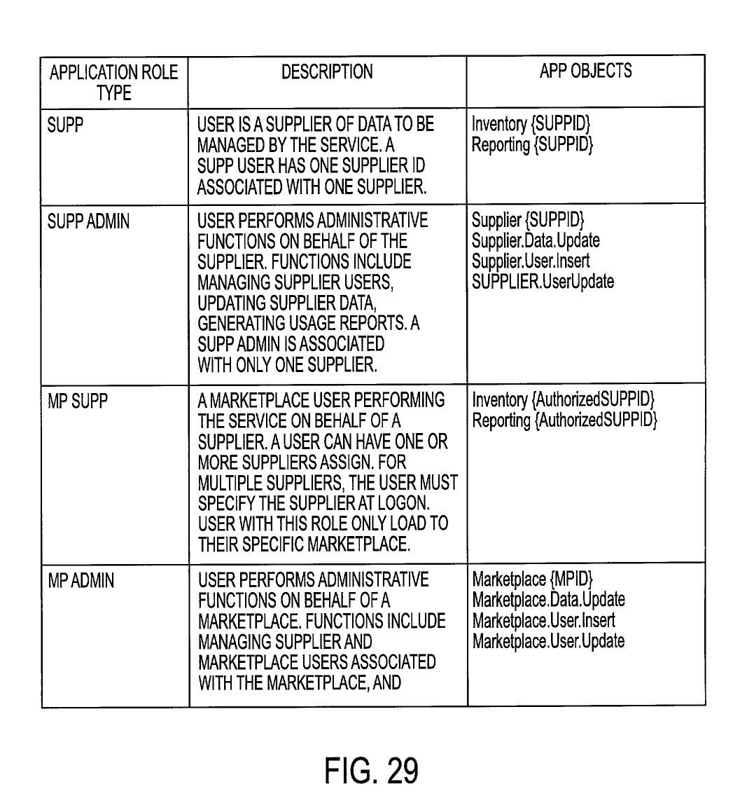

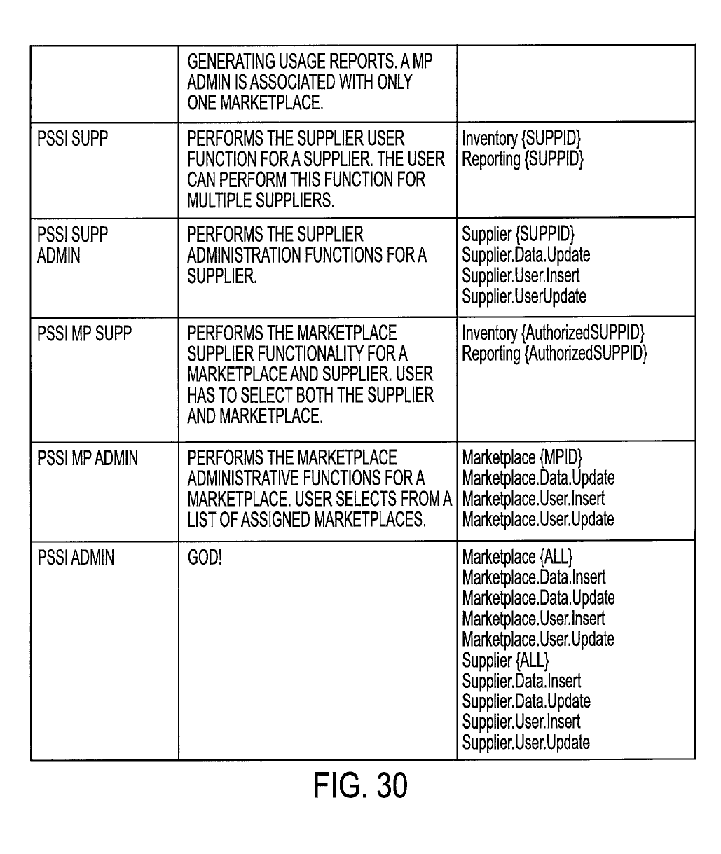

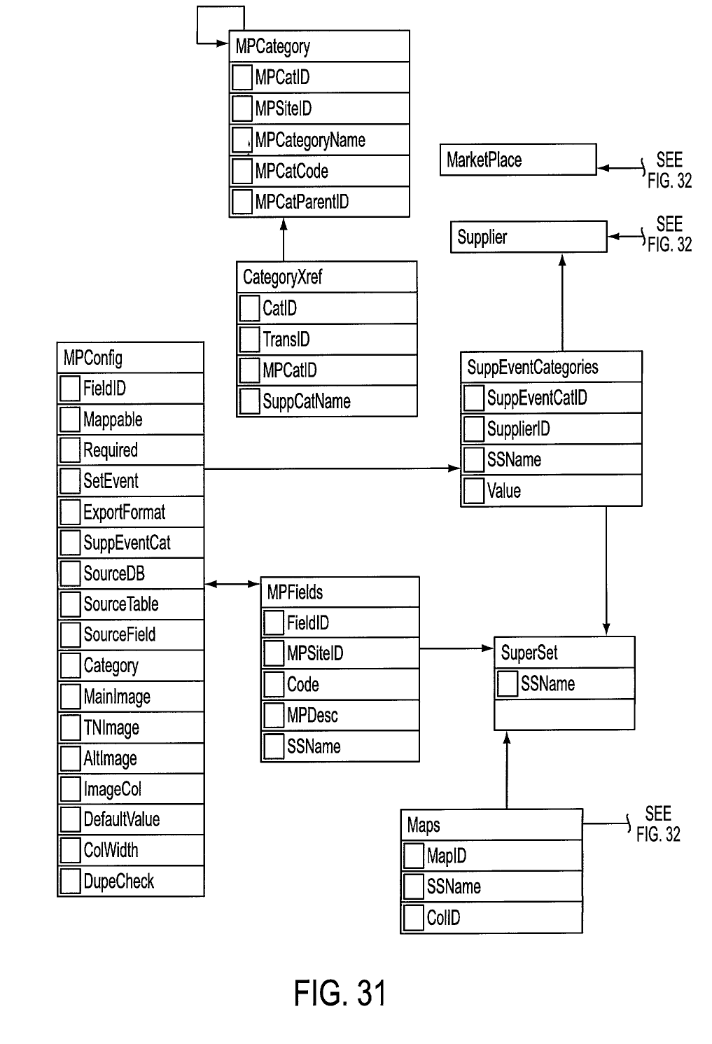

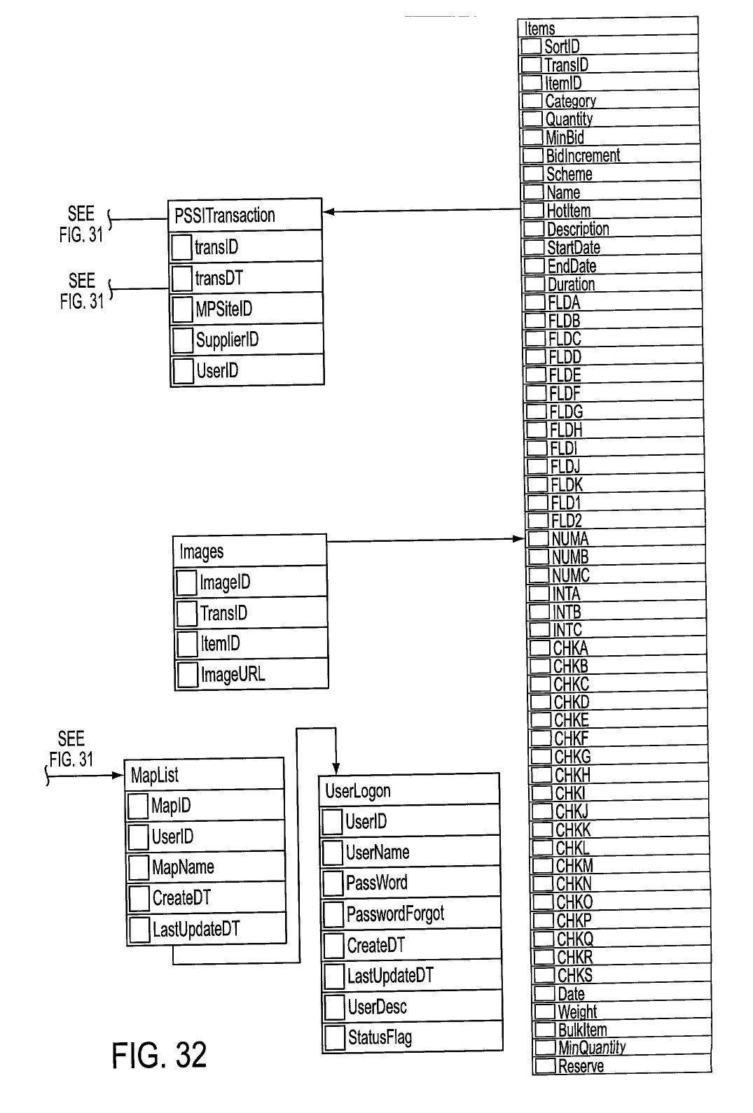

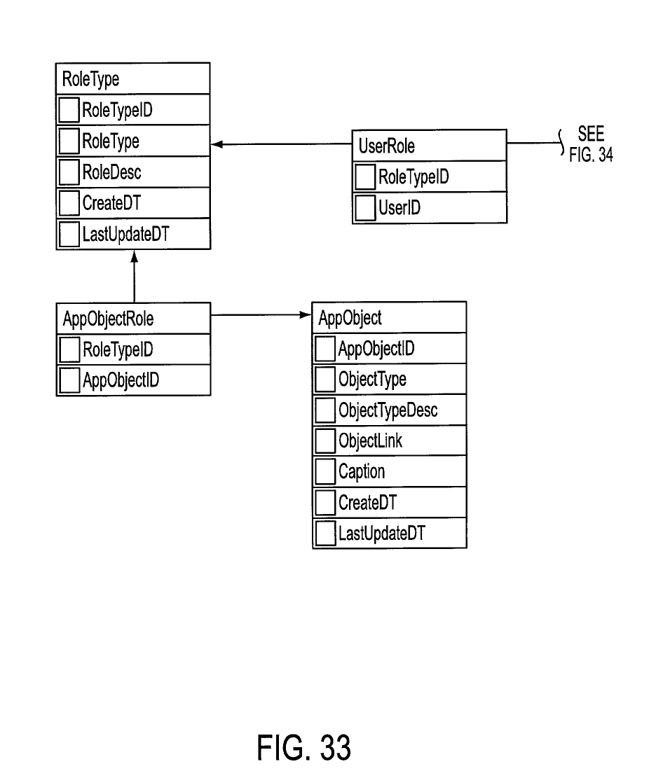

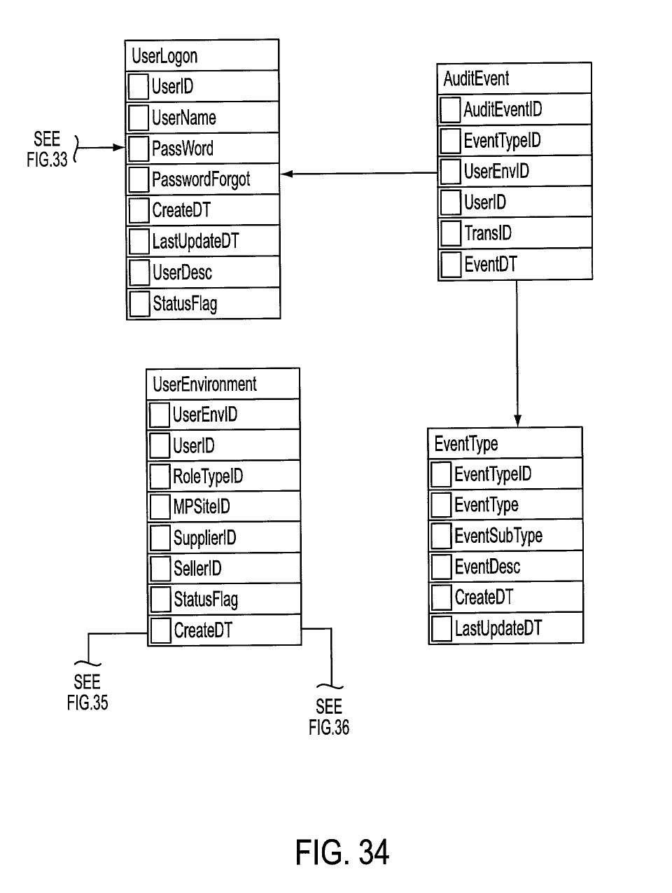

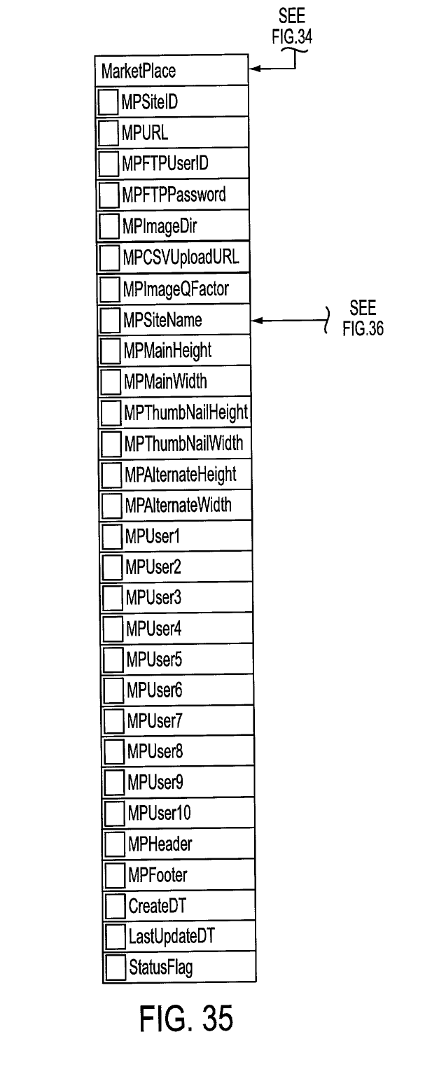

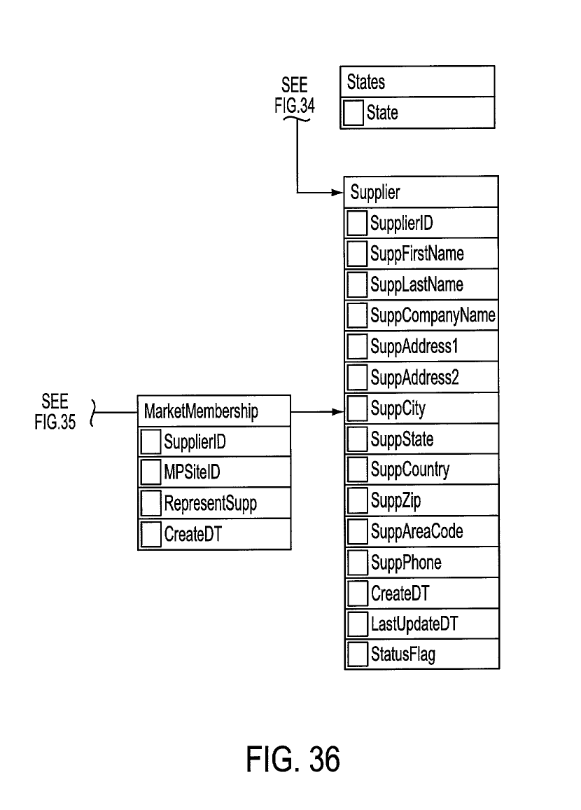

For administrators, a workspace is available to allow the administration of the supplier and marketplace information, and the configuration information for the inventory management workspace (column setup and column configuration). FIGS. 29-30 show the various application role types and the related objects. FIGS. 31-36 show a representation of the data structure in graphical form with its relationships.

### User Environment

The session environment is determined for each user during logon. The different application role types provide access and visibility to different applications. The main Application Role Types are listed in the following table with a description.

App Objects keys: SUPPID—Supplier ID that is approved for the role.

AUTHORIZESSUPPID—specific Supplier ID that a Marketplace can represent

MPID—Marketplace ID that is approved for the role.

The User Environment is defined by the user according to the table of FIGS. 29-30. The user is prompted to select a supplier and/or marketplace based on the requested role. The selection of a supplier/marketplace will then be set for the remainder of the session and available for use by each of the application objects.

### Administrative Tasks

The administrative tasks are designed to be reused. The following series of threads will describe all aspects of the administration of the service through the various roles. The initialization tasks are generally only performed by an administrator.

### Initialization Tasks

The initialization task is be performed by an administrator. The following tables are populated via stored procedures:

1. SuperSet—contains an all-inclusive set of marketplace item data fields.

2. AppObject—list of application objects that drive the view for a specific role.

3. RoleType—types of roles that a user can play.

4. AppObjectRole—link between a roletype and the application objects. Identifies what application objects a role type can access.

5. EventType—list of events and subevents that the service logs.

6. States—List of state names to be used for addresses throughout the service.

The ‘clean’ databases will initially only contain a user record for the Administrator. The administrator's functions that are required prior to any other access to the service include the configuration of a marketplace and a supplier. Once that is complete for at least one marketplace and one supplier, the administrator can begin to add other users to the service.

### Administrator Common Task

The Administrator log onto to the service. The email and password are authenticated and the event is logged to the AuditEvent table. The user selects the role of Administrator. The list of application objects is extracted from the AppObject table and the view is presented.

### Configuration of Marketplace

One option available to the administrator is access to configure a Marketplace. The administrator is presented with a form of all the marketplace fields. Included in the marketplace configuration is the specification of the URLs and FTP access to the marketplace. AMService may provide some ‘test connection’ functionality to validate the configuration data entered. The administrator enters all the required data and selects Insert. The record is added to the MarketPlace table and assigned a unique identifier. The event (ADMINISTRATION: AddMarketplace) is recorded in the AuditEvent table.

Once the marketplace is defined the administrator defines the Marketplace fields. The form is displayed to the current marketplace that lists the superset field name. If the marketplace uses the field, the administrator enters the name used on the marketplace and a brief description.

The administrator also defines the categories that are defined on the site. This data may be stored in the category.ini file on OSA sites. The administrator can either import the category.ini or has to manually enter this data for the marketplace.

The final step to configure the marketplace is to define the marketplace column setup. This data defines what fields for a marketplace are required, mappable, if there are default values, and an export format. The Administrator defines the column setup information for the marketplace. There are also references to the ‘event’ level data items that are defined for some categories to tie these to the SuppEventFields and allow an override through the upload of the item data to the server.

### Configuration of Supplier

The administrator can configure a Supplier. A form is presented for the administrator to enter the supplier specific information. Once all required fields have been defined, the administrator selected insert and the record is added to the Supplier table. The event is recorded into the AuditEvents table (ADMINISTRATION:AddSupplier)

There is an association between a marketplace and a supplier that can be approved by the supplier. The marketplace can play the role of Marketplace Supplier, which allows a marketplace to use the service as a representative of a supplier. When the supplier is configured, the Administrator indicates whether a marketplace can represent the supplier in this role or not.

The inventory data contains fields that across all inventory batch loads. The supplier may want to define these fields once for all inventory items. These fields are assigned in the SuppEventFields table. The administrator defines these items for the current supplier.

### Add Amservice User

Upon successful logon and authentication, another application object available to the administrator is to add users to the service. As Administrator, all levels of users can be added and configured for specific roles.

The administrator is presented with the form from UserLogon to identify the user via email address and password. The user is then associated with one or more specific roles through the userid. Using the UserID and Roletype, the administrator configures the users environment. This entails defining the marketplace and supplier for this user and the associated seller id. This data is inserted into the UserEnviromnent table. Depending of the RoleType, a user can be associated with multiple marketplace and multiple suppliers. The available supplier and marketplace data is limited to those previously defined by the administrator. The event (ADMINISTRATOR:AddUser) is recorded in the AuditEvent Table.

### Operational Tasks

Now the service is configured with at least one marketplace, one supplier and an initial user. That initial user can have multiple roles. We'll look at each role and describe the thread.

### Supplier Administration

There may be one supplier administrator per supplier. This user is identified by the User ID. The UserId and role Type are used in Usp UserEnvironment to extract the supplier for this user. There may be no interface to allow the SuppAdmin to delete supplier data or supplier user data, although they can set supplier user data to inactivate state. The functionality available to the supplier administrator is to update supplier data and insert/update supplier user data.

### Update Supplier Data

The supplier administrator logs on and is authenticated. Updating the supplier data is an application object available. The user selects update and a form is generated with the current settings for the supplier. This form includes the basic supplier data in the Supplier table joined on supplier id with the SuppEventFields information. The administrator can update the data. Selects cancel or update on complete. On Update, Usp UpdateSupplier is called to update the Supplier Table. The event (ADMINISTRATION:UpdateSupplier) is recorded in the AuditEvent table identified by roletype and user event id.

### Adding Supplier User

The supplier administrator can access the application object to create a new supplier user for their specific supplier. The form is presented to allow entry of the supplier user data. The data contains fields joined from the UserLogon, UserRole, and UserEnvironment tables. The only available role is SUPP. The administrator associates a marketplace and seller id for the user and adds to the UserEnvironment table.

### Update Supplier User

The supplier administrator has the application object to update the supplier user data. The user requests a list of users for the current supplier and select the specific user to update. {Select ulUserName, ul.Password, ue.sellerid, ul.StatusFlag, ur.RoleType from UserEnvironment ue, UserLogon ul, UserRole ur where ue.SupplierID=<suppid> and ue.UserID =<userid> and ur.UserID=<userid>}. The administrator is presented with a form with user specific information with only editable fields enabled. This update will include just adding a new role for the existing user (for the one case that the SUPP ADMIN wants to add a SUPP role to themselves). Administrator performs updates. Selects cancel or update on complete. On Update the UserLogon and UserEnvironment tables are updated with the changes. The event {ADMINISTRATOR:UpdateUser} is recorded in the AuditEvent table.

### Marketplace Administrator

A marketplace administrator is defined for an individual marketplace. The user id and roletype are used to access the UserEnvironment table to extract the Marketplace id for this administrator.

This functionality is available to the Administrator and MP Administrator. The Administrator can perform this function for multiple marketplaces while the MP Administrator has access to a defined supplier.

### Update Marketplace Data

The marketplace administrator can update the marketplace information for their specific marketplace. A form is presented with the data for the marketplace to allow update. Any changes to the URL or FTP data is verified before entry into the database. When complete, the event (ADMINISTRATION:UpdateMarketplace) is recorded to the AuditEvent table.

### Adding Marketplace User

The administrator selects the application object to add a marketplace user. They are presented a form with the data from the UserLogon table joined with the MarketMembership and UserEnvironment tables. The administrator selects the roletype MP SUPP, a supplier id, and a seller id. (The supplier id is extracted from the UserEnvironment for suppliers that have granted representation to this marketplace. {Select SupplierID from MarketMembership where MPSiteID=<marketplaceid> and RepresentSupp=true}). An entry is made in the UserLogon table, and the UserEnvironment table for the new user. The event (ADMINISTRATION: AddMarketPlaceUser) is recorded to the AuditEvent table.

### Update Marketplace User

The administrator updates a marketplace user from the application object. A list of marketplace users is extracted from the UserEnviromnent for the specific marketplace. The administrator selects a user and the dat is presented on a form. {Select ul.username, ul.password, ul.statusflag, ue.sellerid from UserLogon ul, UserEnvironment ue where ul.userid=<userid> and ue.MPSiteId=<mpsiteid>} The administrator updates the information. This update has to include the function of adding a new role to an existing marketplace user (for the case of the MP ADMIN granting the role of MP SUPP to themselves). The UserLogon, UserRole, and UserEnvironment tables are updated to reflect the changes. The event (ADMINISTRATION:UpdateMarketplaceUser) is recorded to the AuditEvent Table.

### Generate Marketplace Reports

The system provides some functionality to generate reports based on marketplace id and there will probably be some usage report that just marketplace administrator has access to (and Admin and Marketplace Admin).

### Supplier User

The role of supplier user in the simplest path which provides the Marketplace Supplier and Supplier roles reuse. The application objects available to the supplier are the inventory management applet, report generation at the user level and some personalization object (change password/preferences).

The Marketplace Supplier gains access to the same functionality but only for the suppliers that have been configured to allow that marketplace to represent them.

### Inventory Management Workspace

The Supplier User performs the inventory management function by selecting this application object. The user specifies the source of the inventory data, which can be in multiple formats (csv, excel, tab delimited, xml). The User identifies the source and the data is processed by the service.

### Grid Map

The data is first loaded into an ADO recordset. The recordset can be associated with a temporary SQL table. The data is parsed into fields and returned to the client as an XML document. The user now performs the field mapping to the superset fields. The mapped inventory data is then transferred to the server. A new transaction is created for this user/supplier/marketplace with the transaction id being the main identifier for this session activity. The items are loaded into the Items table. DTS may be used for this loading.

### Image Map

If the user wants to associate images with the inventory data, the image map functionality is available. The user can associate any number of images to an individual inventory item. The image may reside at a plurality of local and remote image locations.

Once the image mapping is complete, the user submits the image map definition XML file to the server for parsing. The image references (URLs) are loaded into the Image table with the associated item id and transaction id.

### Category Xref

For the marketplace to interpret and manage the user's inventory data, the user and the marketplace have to agree on common category names. The user maps its internal category names to the names used by the marketplace. The service presents a list of the user's categories and those of the marketplace to allow the user to associate the two. The load to the marketplace cannot be completed until this cross-reference is performed for all user categories

In the foregoing specification, the present invention has been described with reference to specific various embodiments thereof. Although the invention has been described in terms of various embodiments, those skilled in the art will recognize that various modifications, embodiments or variations of the invention can be practiced within the spirit and scope of the invention as set forth in the appended claims. All are considered within the sphere, spirit, and scope of the invention. The specification and drawings are, therefore, to be regarded in an illustrative rather than restrictive sense. Accordingly, it is not intended that the invention be limited except as may be necessary in view of the appended claims.

We claim:

1. A method for processing information comprising the steps of:
selecting a first label from a first list of labels to identify a first set of data;
selecting a second label from a second list of labels to identify a second set of data;
applying a first rule associated with said first set of data based on the selection of said first label; and
applying a second rule associated with said second set of data based on the selection of said second label.

2. The method of claim 1, wherein at least one of the first set of data and the second set of data is a column.

3. The method of claim 1, wherein at least one of the first set of data and the second set of data is a field.

4. The method of claim 1, wherein at least one of the first rule and the second rule is applied to the content of a cell in a column based on the content of said cell.

5. The method of claim 1, wherein at least one of the first rule and the second rule is applied to the content of a first cell in a column based on the content of a second cell.

6. The method of claim 1, further comprising the step of: applying a third rule to said first set of data based on the selection of said first label.

7. The method of claim 1, further comprising the step of:
after said selecting a first label step, removing said first label from said first list of labels to result in said second list of labels.

8. The method of claim 1, wherein said first list of labels is identical to said second list of labels.

9. The method of claim 1, further comprising the step of: outputting the result of said first and second applying steps to a remote application.

10. The method of claim 1, wherein said first applying step comprises the step of: generating a third set of data based on said first set of data.

11. The method of claim 1, wherein said first applying step comprises the step of: replacing said first set of data with a third set of data.

12. The method of claim 1, wherein said first rule performs the step of data scrubbing on said information.

13. The method of claim 1, wherein said first rule filters said information.

14. The method of claim 1, wherein said first rule applies source rules to said information.

15. The method of claim 1, wherein said first rule applies destination rules to said information.

16. The method of claim 1, wherein said first rule applies cleanup rules to said information.

17. The method of claim 1, wherein said first rule applies derivation rules to said information.

18. The method of claim 1, wherein said first rule applies transformation rules to said information.

19. The method of claim 1, wherein said first rule applies mapping rules to said information.

20. The method of claim 1, said first applying step comprising the steps of:
determining at least one of a supplier of the information and a recipient of the information;
determining to apply said first rule from a set of rules based on at least one of said supplier and said recipient; and
applying said first rule.

21. The method according to claim 1, further comprising the steps of:
determining at least one a header row of the information, a supplier of the information and a recipient information;
storing said first and second selecting steps with at least one of an indication of said header row, said supplier, and said recipient as part of a knowledgebase; and
when processing new information with an indication, matching at least one of said header row, said supplier and said recipient, performing said first and second selecting steps on said new information.

22. A system for processing information comprising:
a first database having a first set of fields;
a second database having a second set of fields;
a processor for applying a mapping between at least some of said first set of fields to at least some of said second set of fields, said processor applying said mapping based on labels associated with said first and said second sets of fields.

23. A system for processing information comprising:
means for selecting a first label from a first list of labels to identify a first set of data;
means for selecting a second label from a second list of labels to identify a second set of data;
means for applying a first rule associated with said first set of data based on the selection of said first label; and
means for applying a second rule associated with said second set of data based on the selection of said second label.

24. The system of claim 23, wherein at least one of the first set of data and the second set of data is a column.

25. The system of claim 23, wherein at least one of the first set of data and the second set of data is a field.

26. The system of claim 23, further comprising:
means for applying a third rule to said first set of data based on the selection of said first label.

27. The system of claim 23, further comprising:
means for removing said first label from said first list of labels to result in said second list of labels after operation of said means for selecting a first label.

28. The system of claim 23, wherein said first list of labels is identical to said second list of labels.

29. The system of claim 23, further comprising:
means for outputting the result of said first and second applying steps to a remote application.

30. The system of claim 23, wherein said means for first applying further comprises:
means for generating a third set of data based on said first set of data.

31. The system of claim 23, wherein said means for first applying comprises:
means for replacing said first set of data with a third set of data.

32. The system of claim 23, said means for first applying comprises:
means for determining at least one of a supplier of the information and a recipient of the information;
means for determining to apply said first rule from a set of rules based on at least one of said supplier and said recipient; and
means for applying said first rule.

33. The system according to claim 23, further comprising:
means for determining at least one of a supplier of the information and a recipient information; and
means for storing the output of said first means for selecting and said second means for selecting with at least one of an indication of said supplier and said recipient as part of a knowledgebase,
wherein, when processing new information with an indication matching at least one of said supplier and said recipient, said first means for selecting and said second means for selecting select labels for said new information.

34. A computer-readable medium having a program for processing information, said program comprising the steps of:
selecting a first label from a first list of labels to identify a first set of data;
selecting a second label from a second list of labels to identify a second set of data;
applying a first rule associated with said first set of data based on the selection of said first label; and
applying a second rule associated with said second set of data based on the selection of said second label.

35. The computer-readable medium according to claim 34, said program further comprising the steps of:
determining at least one of a supplier of the information and a recipient information;
storing said first and second selecting steps with at least one of an indication of said supplier and said recipient as part of a knowledgebase; and
when processing new information with an indication matching at least one of said supplier and said recipient, performing said first and second selecting steps on said new information.
